(19) United States
(12) Patent Application Publication
(10) Pub. No.: US 2006/0183092 A1
(43) Pub. Date: Aug. 17, 2006

(54) Typing game machine

(75) Inventor: Junichi Kogo, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE CORP., Tokyo (JP)

(21) Appl. No.: 11/337,169

(22) Filed: Jan. 23, 2006

(30) Foreign Application Priority Data
Jan. 24, 2005 (JP) 2005-015904
Jan. 24, 2005 (JP) 2005-015905
Jul. 12, 2005 (JP) 2005-203460

(51) Int. Cl. G09B 13/00

(52) U.S. Cl. 434/227; 434/169; 434/322

(57) ABSTRACT

There is provided a typing game machine which may change a display mode of a predetermined character array to be displayed. For example, the predetermined character array is partially or totally non-displayed upon satisfaction of a predetermined condition such that the player may type characters by guessing non-displayed part of the character array. And the predetermined character array is partially or totally replaced by a group of selective character arrays being composed of a plurality of candidate character arrays such that the player type characters in referring to the candidate character arrays. Since such display modes are available, the player may enjoy the game in addition to the typing practice. Further, the skilled player can enjoy the typing game with this typing game machine.

### CROSS REFERENCE TO RELATED APPLICATIONS

This application is based upon and claims the benefits of priorities from Japanese Patent Application Nos. 2005-015904 filed on Jan. 24, 2005, 2005-015905 filed on Jan. 24, 2005, and 2005-203460 filed on Jul. 12, 2005, the entire contents of which are incorporated herein by reference.

### FIELD OF THE INVENTION

The present invention relates to a typing game machine in which a game is conducted based on true/false determination by comparing a predetermined character array displayed on an image display means and a character array inputted through a keyboard operation. More specifically, it relates to a typing game machine in which game amusement is enhanced by changing a display mode of the predetermined character array to be displayed on the image display means.

### RELATED ART

In the conventional typing game by which type input through a keyboard of a word processor or the like is practiced, a player types the keyboard within a predetermined period of time so as to input the same character array shown on a display or the like such that the player may learn the key arrangement by heart and acquire an effective typing skill. And such means with which the player can play the typing game may be a typing game machine of a cabinet type which is installed in an arcade or the like and with which unspecified many players can play the typing game by paying a predetermined fee and another typing game machine configured with each personal computer (PC) such that the typing game can be played with each PC by installing into each PC a typing game program (software) having been purchased by each player.

Further, as such a typing game machine, there has been introduced a typing game machine with which the player types not only a character array randomly displayed, but also conversation contents of characters displayed and lyrics of music played. For example, Japanese unexamined patent publication number 2002-268534 (pages 8 to 9, FIGS. 4 to 9) discloses a typing game machine in which the user types lyrics of practice music reproduced by a computer such that the player may improve his or her typing skill in precision and accurateness based on information obtained from his or her ears as opposed to information obtained from his or her eyes such that a practice character array is displayed on a screen.

### SUMMARY OF THE INVENTION

According to the present invention, a new game mode is configured that part or all of the character array to be displayed on an image display means is not shown (or is non-displayed) upon satisfaction of a predetermined condition such that the non-displayed part or all of the character array has to be typed based on his or her memory or guess. And a new game mode is configured that part or all of the character array to be displayed on an image display means is replaced by a group of selective character arrays including the part or all of the character array as one of the selective character arrays such that the correct character array may be typed with the help of the group of selective character arrays. Therefore, there is provided a typing game machine with which even a skilled player in typing can enjoy the typing game very much.

Further features of the present invention, its nature, and various advantages will be more apparent from the accompanying drawings and the following description of the preferred embodiment.

### BRIEF DESCRIPTION OF THE DRAWINGS

FIG. 1 is a perspective view of a typing game machine of embodiment 1.

FIG. 2 shows general contents displayed on a first liquid crystal display prior to starting a typing game.

FIG. 3A shows general contents displayed on a second liquid crystal display while the typing game is in progress.

FIG. 3B shows general contents displayed on the second liquid crystal display while the typing game is in progress.

FIG. 4A shows general contents displayed on the second liquid crystal display while the typing game is in progress.

FIG. 4B shows general contents displayed on the first liquid crystal display while the typing game is in progress.

FIG. 4C shows general contents displayed on the first liquid crystal display while the typing game is in progress.

FIG. 5 shows general contents displayed on the first liquid crystal display after the typing game is completed.

FIG. 6A shows general screen contents displayed on the first liquid crystal display when blank character regions are displayed in which the number of blank characters is set to be three characters.

FIG. 6B shows general screen contents displayed on the first liquid crystal display when blank character regions are displayed in which the number of blank characters is set to be five characters.

FIG. 6C shows general screen contents displayed on the first liquid crystal display when blank character regions are displayed in which the number of blank characters is set to be eight characters.

FIG. 7 shows general screen contents displayed on the first liquid crystal display when the blank character regions are displayed and one phrase is completely typed.

FIG. 8 shows the replacement lottery table of the embodiment 1.

FIG. 9 shows the blank character number determination table of the embodiment 1.

FIG. 10 is a plan view of a keyboard provided to the typing game machine of the embodiment 1.

FIG. 11A is a schematic cross-sectional view of one of plurality of keys provided on the keyboard.

FIG. 11B is a plan view of a keyboard that may be provided to the typing game machine of the embodiment 1.

FIG. 11C is a plain view of a keyboard that may be provided to the typing game machine of the embodiment 1.

FIG. 12 is a system block diagram showing a system comprising the typing game machine and a server of the embodiment 1.

FIG. 13 is a block diagram showing graphically a control system of the typing game machine of the embodiment 1.

FIG. 14 is a schematic view of a musical composition data storage area (or music data storage area) of the HDD in the typing game machine of the embodiment 1.

FIG. 15 is a flow chart of the main process program for the typing game machine of the embodiment 1.

FIG. 16 is a flow chart of a musical composition selection process program (or music selection process) for the typing game machine of the embodiment 1.

FIG. 17 is a flow chat of a typing game conduction process program for the typing game machine of the embodiment 1.

FIG. 18 is a flow chart of a character array display process program for the typing game machine of the embodiment 1.

FIG. 19 is a flow chart of a correct character array displaying process program for the typing game machine of the embodiment 1.

FIG. 20 is a flow chart showing the main process program of the typing game machine of the embodiment 2.

FIG. 21 is a flow chart of a typing game conduction process program for the typing game machine of the embodiment 2.

FIG. 22 is a flow chart of a third typing game conduction process program for the typing game machine of the embodiment 2.

FIG. 23 shows general game mode selection screen displayed on the first liquid crystal display in selecting a game mode.

FIG. 24A shows general contents displayed on the second liquid crystal display while the typing game is in progress on the basis of the ultra-hard mode.

FIG. 24B shows general contents displayed on the first liquid crystal display.

FIG. 25 shows general contents displayed on the first liquid crystal display while the typing game is in progress on the basis of the ultra-hard mode.

FIG. 26A shows general screen contents displayed on the first liquid crystal display when two selective character arrays are displayed in replacement of part of a base character array.

FIG. 26B shows general screen contents displayed on the first liquid crystal display when three selective character arrays are displayed in replacement of part of a base character array.

FIG. 26C shows general screen contents displayed on the first liquid crystal display when three selective character arrays are displayed in replacement of part of a base character array.

FIG. 27A shows general screen contents displayed on the first liquid crystal display when the two selective character arrays are displayed and one phrase is completely and correctly typed.

FIG. 27B shows general screen contents displayed on the first liquid crystal display when the two selective character arrays are displayed and one phrase is completely and correctly typed.

FIG. 28 shows the replacement lottery table of this embodiment.

FIG. 29 shows the selective number determination table of this embodiment.

FIG. 30 is a flow chart of a typing game conduction process program for this typing game machine.

FIG. 31 is a flow chart of a musical composition selection process program (or music selection process program) for the typing game machine of the embodiment 1.

FIG. 32 is a flow chart of a correct character array confirmation process program for the typing game machine of this embodiment.

### DESCRIPTION OF THE PREFERRED EMBODIMENT

Hereinafter, according to the present invention, a detailed explanation will be made for typing game machines of embodiments 1 and 2 embodied in a cabinet-type typing game machine 1 placed at a game arcade and other places by referring to the figures.

### Embodiment 1

In this instance, the typing game machine 1 of the embodiment 1 is constituted in such a manner that a musical composition is reproduced from speakers, lyrics are displayed in sequence on a display as the reproduced musical composition is streamed, and a player uses a keyboard to type the thus displayed lyrics in sequence, thereby playing a game. Further, the typing game to be played is constituted of a plurality of stages according to the total number of tune numbers of musical compositions to be reproduced, and when the player makes typing errors less than a predetermined number at the completion of one stage, the player can proceed to a stage which corresponds to the next tune number of the musical composition, thereby continuing to play the typing game.

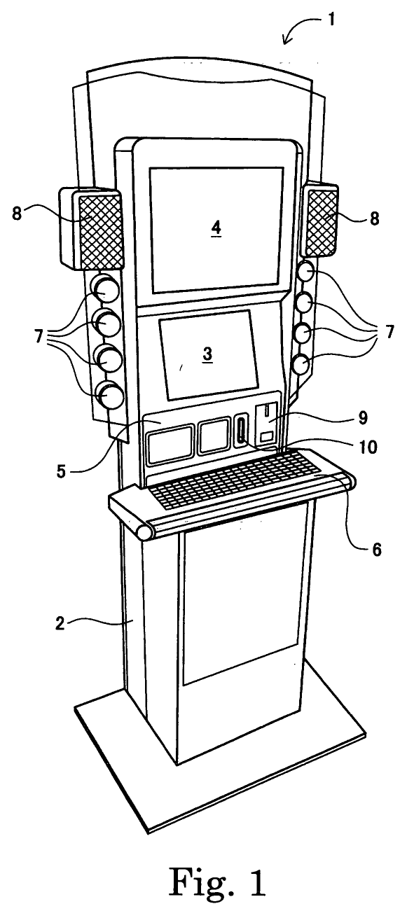

First, an explanation will be made for a general constitution of the typing game machine 1 of the embodiment 1 by referring to FIG. 1. FIG. 1 is a perspective view of the typing game machine in the embodiment 1.

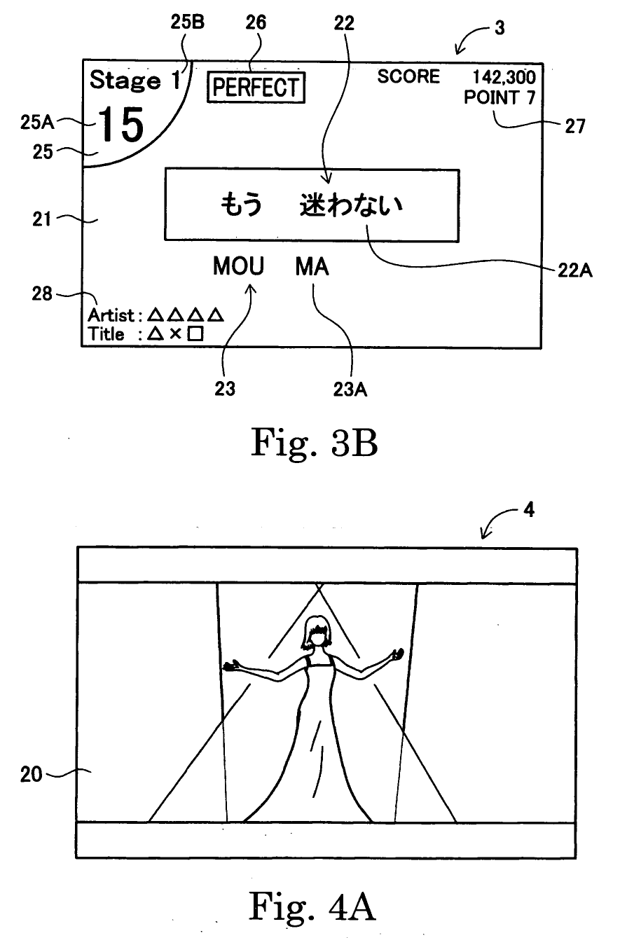

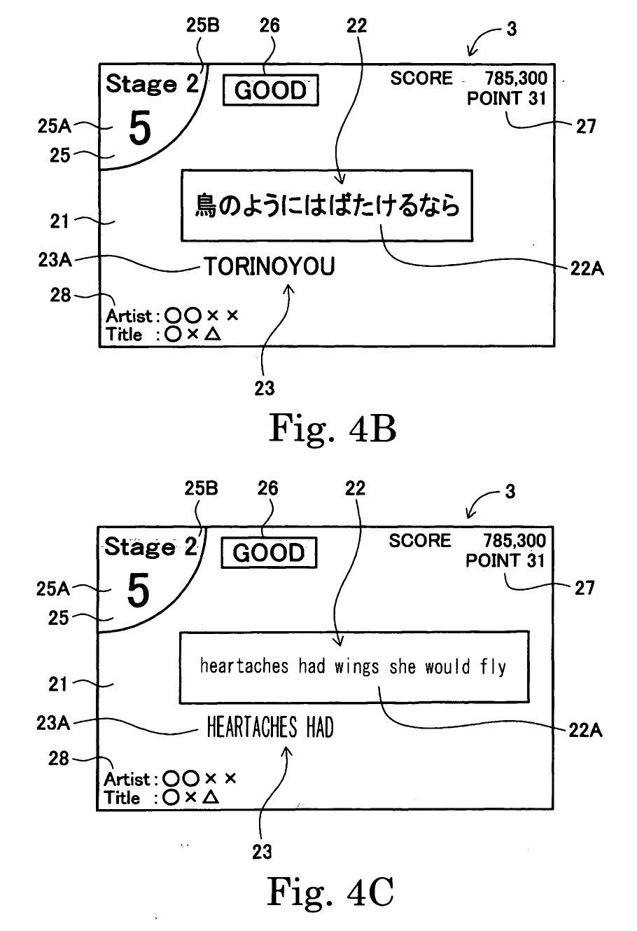

As shown in FIG. 1, the typing game machine of the embodiment 1 is basically composed of a cabinet 2 which forms an outer shape of the typing game machine 1, a first liquid crystal display 3 which displays a main game screen (refer to FIGS. 3B and 4B), a second liquid crystal display 4 which is located above the first liquid crystal display 3 and displays effect images such as promotion video and advertisement (refer to FIGS. 3A and 4A), a center panel 5 which is provided below the first liquid crystal display 3 and in which an insertion slot for coins and cards is formed, a keyboard 6 operated by the player, external illumination LEDs 7 provided on right and left sides of the first liquid crystal display 3 and a pair of speakers 8 arranged on right and left sides of the second liquid crystal display 4. Hereinafter, an explanation will be made for each component.

The first liquid crystal display 3 is a liquid crystal display disposed approximately at the center of the front face of the cabinet 2 in a state of being inclined with a predetermined angle, and the display 3 is thus slanted backward at a predetermined angle. Then, the first liquid crystal display 3 displays lyrics of the musical composition reproduced from the speakers 8, results of typing operation by the player and game information on the progress of the typing game such as scores thereof (information necessary for the player to conduct the game) upon execution of the typing game (refer to FIGS. 3B and 4B).

Then, the second liquid crystal display 4 disposed separately above the first liquid crystal display 3 is a liquid crystal display similar to the first liquid crystal display, however, the second liquid crystal display 4 displays effect images of the effects of the typing game when the typing game is conducted.

In this instance, the effect images displayed on the second liquid crystal display 4 are different from those on the first liquid crystal display 3 in the content thereof, and not directly necessary for the player to conduct the game, but the effect images may assume an auxiliary role in warming up the typing game. For example, in the typing game machine 1 of the embodiment 1, a musical composition of a certain singer is reproduced for the musical composition of the game and the player uses the keyboard 6 to enter lyrics of the musical composition as the game proceeds. A promotion video (hereinafter abbreviated as “PV”) related to the musical composition is shown on the second liquid crystal display 4 (refer to FIGS. 3A and 4A). Therefore, the player can play the typing game in an environment of a pseudo-live show that an artist who is singing a song is shown as the musical composition is played such that the player may not get bored with the game. A detailed explanation will be made later for the contents displayed on the first liquid crystal display 3 and the second liquid crystal display 4.

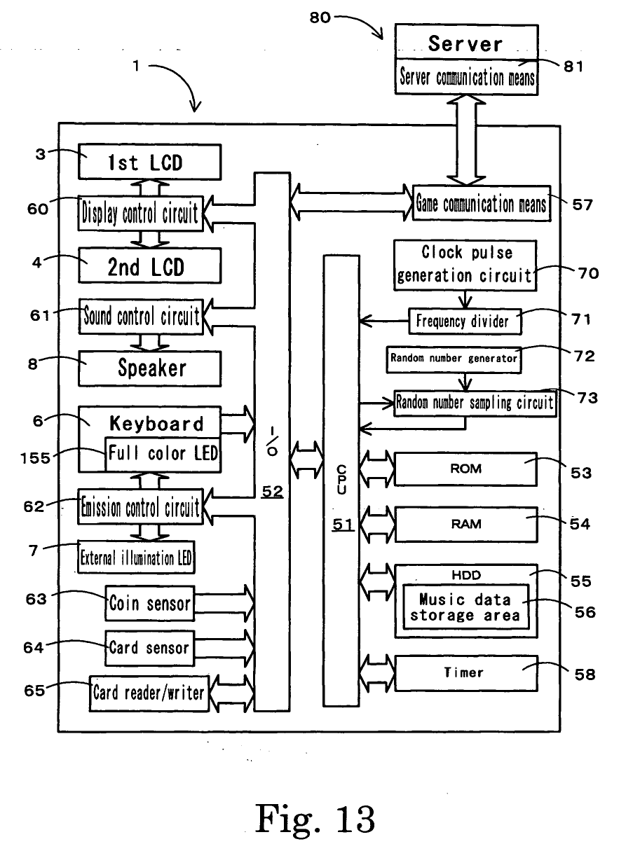

Further, a center panel 5 is provided with a coin insertion slot 9 and a card insertion slot 10. The coin insertion slot 9 is an insertion slot into which coins such as 100-Japanese-yen coins (or quarters in the US dollar) are inserted. A coin sensor 63 is disposed on the coin insertion slot 9, and when coins are inserted into the coin insertion slot 9, a coin detection signal is output to a CPU 51 via the coin sensor 63 (refer to FIG. 13) and the CPU 51 detects that coins have been inserted.

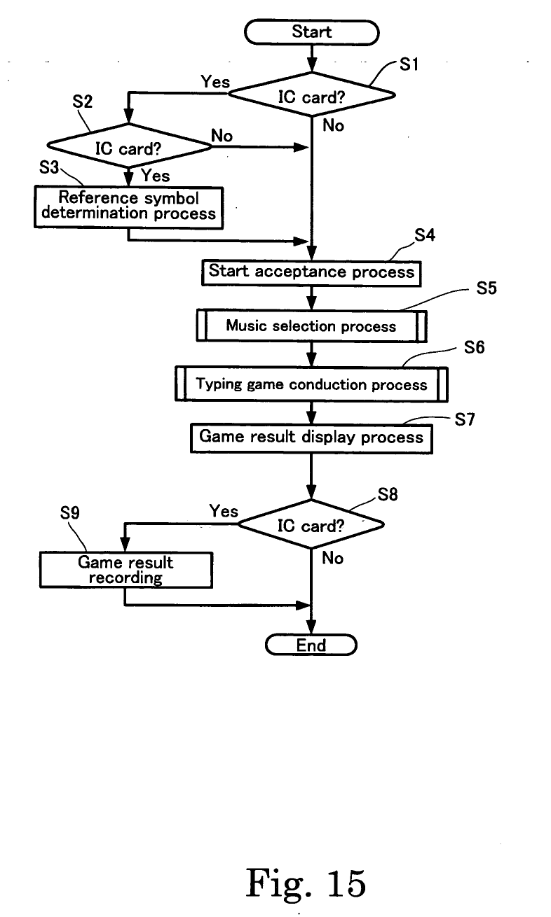

In addition, the card insertion slot 10 is an insertion slot into which an IC card (not illustrated) with a built-in IC tag to record results of the typing game is inserted. A card sensor 64 to be explained later and a card reader/writer 65 are arranged inside the card insertion slot (refer to FIG. 13). Where the IC card is inserted into the card insertion slot 10, the card sensor 64 detects this card insertion. In this instance, the IC card used in the typing game machine 1 of the embodiment 1 stores game results obtained by the player up to the previous game (acquired scores, points and others) which are possessed in the built-in IC tag, making it possible to display the thus stored game results to the player by a predetermined operation. To be more specific, where the IC card is detected by the card sensor 64, the card reader/writer 65 reads the game results of the typing game from the IC tag or writes new game results into the IC tag (S3 and S9 in FIG. 15).

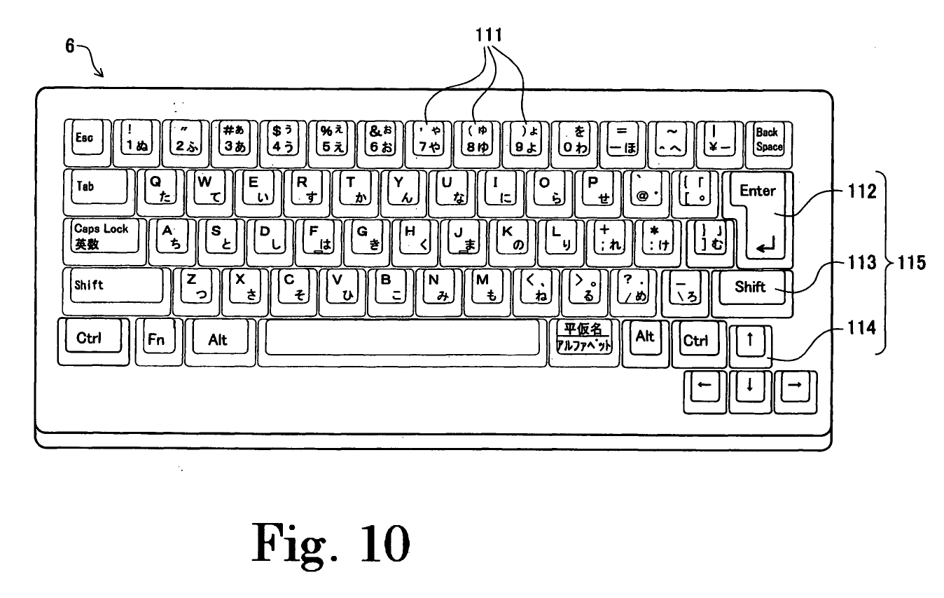

The keyboard 6 is arranged in front of the cabinet 2 in a state of being projected forward, and as will be explained later, it is a Japanese language keyboard 108 in which a plurality of character enter keys for entering “alphabetic letters (A to Z),” “‘Kana [Japanese syllabary]’ (‘a’ to ‘n’),” “numerals (0 to 9) and “symbols (period and comma)” as well as function keys such as the enter key and cursor key are individually arranged (refer to FIG. 10). Then, while the game is in progress, the player types individual keys corresponding to characters, symbols, numerals and others, entering characters to advance the game. Further, prior to starting the game or after completion of the game, the player gives instructions to select and decide musical compositions for the game or the degree of difficulty or to start and execute the game by operating individual keys. Meanwhile, a detailed explanation will be made later for the configuration of the keyboard.

Four external illumination LEDs 7 are arranged on each of the right and left sides of the cabinet 2. The external illumination LEDs 7 are composed of full-color LEDs which can emit a full color and provide a variety of illumination effects according to musical compositions reproduced in the typing game machine 1. For example, the illumination effects include color changes of eight external illumination LEDs 7 in all, changes of illumination colors in a predetermined pattern, and blinking the external illumination LEDs 7.

Further, the speakers 8 are arranged on the right and left sides of the second liquid crystal display 4. The speakers 8 are output devices for outputting musical compositions, effect sounds and others that are reproduced in the typing game machine 1. To be more specific, in conducting the typing game, the speakers 8 output music and sound at a predetermined tempo on the basis of audio data and performance data of musical compositions stored in the HDD 55 (refer to FIG. 13).

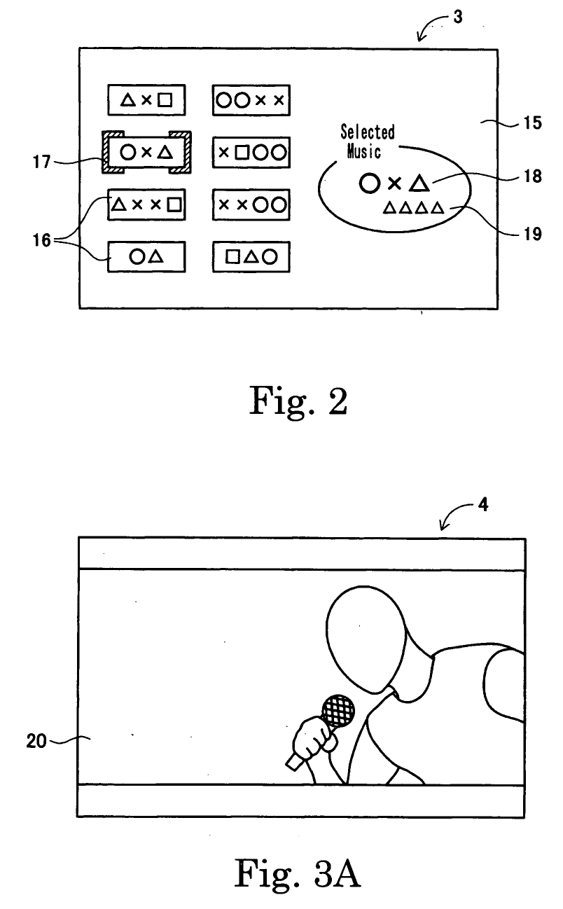

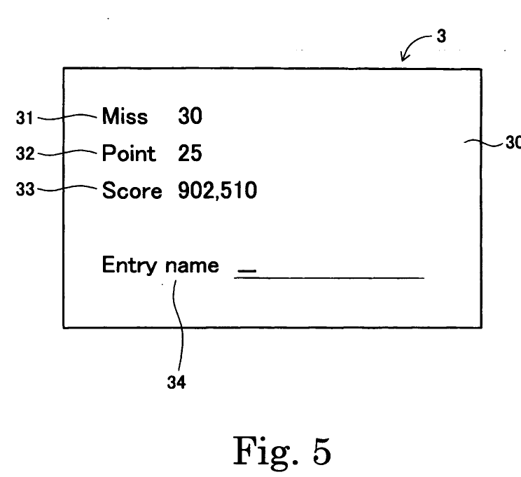

Next, a detailed explanation will be made for contents displayed on the first liquid crystal display 3 and the second liquid crystal display 4 in referring to FIGS. 2 to 5. The contents displayed on the first liquid crystal display 3 and the second liquid crystal display 4 are basically composed of three patterns, namely, a pattern before the beginning of the typing game, a pattern during the typing game, and a pattern after the completion of the typing game. FIG. 2 is a pattern diagram showing the contents displayed on the first liquid crystal display 3 before the typing game is started. FIGS. 3A and 4A show the contents displayed on the second liquid crystal display 4 while the typing game is in progress. FIGS. 3B, 4B and 4C show the contents displayed on the first liquid crystal display 3 while the typing game is in progress. FIG. 5 shows the contents displayed on the first liquid crystal display 3 after the typing game is completed.

In this instance, the typing game machine 1 of the embodiment 1 conducts the typing game as lyrics of a musical composition to be performed are entered. To be more specific, first, the player selects the musical composition to be played from a plurality of musical compositions which are made available. Then, upon starting the typing game, performance data corresponding to musical accompaniment of the thus selected musical composition and audio data corresponding to the singing voice of the artist of the musical composition are reproduced. Further, in association with reproduction of the performance data and the audio data of the musical composition, each phrase of the lyrics of the musical composition is displayed as a character array for the player to enter via the key board 6 in synchronization with the reproduced audio data.

Characters of the character array corresponding to one phrased of the lyrics being displayed are entered via the keyboard 6, thereby allowing the typing game to proceed. Upon completion of the game, results of the typing game (number of typing errors, acquired scores, points and others) are calculated and displayed on the basis of individual typing factors such as correctness of typing and entry timing. Namely, in the typing game of the typing game machine 1, the player competes in his or her skill level of typing characters and others as he or she enjoys the musical composition performed in the game.

First, an explanation will be made for contents displayed prior to starting the typing game in referring to FIG. 2. As shown in FIG. 2, on the first liquid crystal display 3, which is in a stage after a predetermined number of coins are inserted into the coin insertion slot 9 and before the typing game is started, a music selection screen 15 showing a list of musical compositions that can be played by the typing game machine 1 is displayed.

The music selection screen 15 is composed of a playable music title displaying part 16 which displays titles of playable musical compositions, a music selection cursor 17 which can select any of the playable musical compositions in the playable music title displaying part 16, a selected music title displaying part 18 which displays names of musical compositions selected by the music selection cursor 17 and a selected artist name displaying part 19 which displays artist names of the musical composition selected by the cursor.

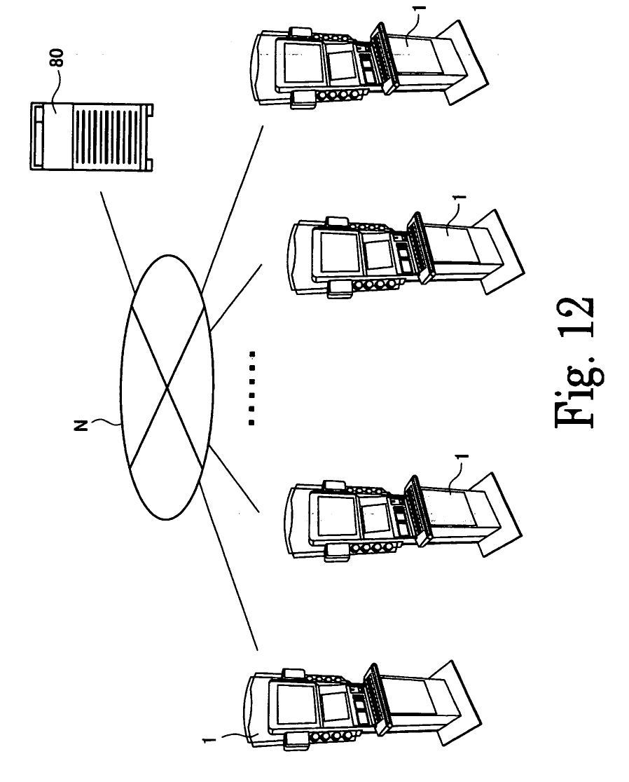

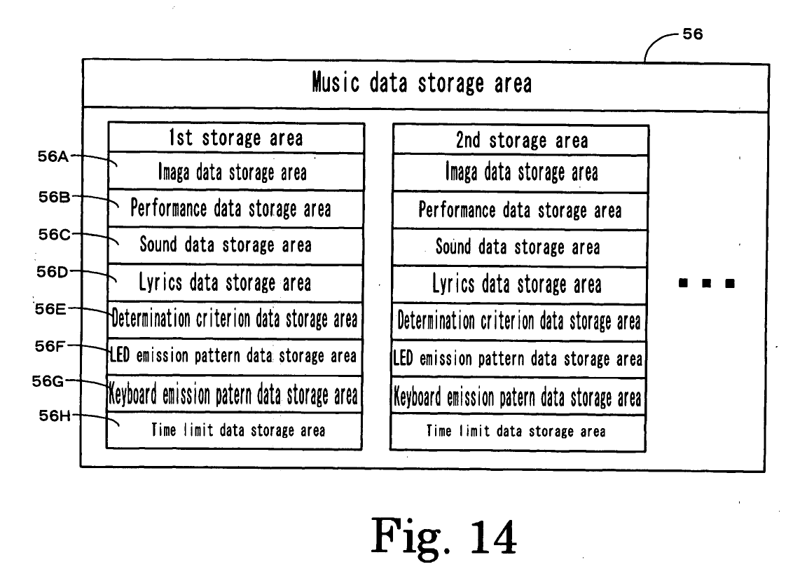

The playable music title displaying part 16 shows titles of playable musical compositions (up to 8 in the embodiment 1) which are available in the current typing game machine 1. In this instance, the playable musical compositions displayed in the playable music title displaying part 16 are musical compositions of which musical composition data (or music data) is stored in the HDD 55 that will be explained later (refer to FIGS. 13 and 14). Further, the stored music data is controlled by a server 80 (refer to FIG. 12), and renewed in sequence. Therefore, the player is allowed to conduct the game by selecting from a plurality of musical compositions including the latest musical compositions renewed by the server 80. Also, the playable music title displaying part 16 may display photos of an artist and PV, in addition to names of musical compositions.

In addition, the music selection cursor 17 can be moved vertically and horizontally on the playable music title displaying part 16 by operating a cursor key 114 on the keyboard 6 (refer to FIG. 10). The selected music title displaying part 18 and the selected artist name displaying part 19 display the title of a musical composition and the name of an artist of the playable music title displaying part 16 at which the music selection cursor 17 is now located.

Then, when an enter key 112 (refer to FIG. 10) is depressed in a state that the music selection cursor 17 is located at the playable music title displaying part 16 in which the title of a desired musical composition is displayed, the musical composition to be played is determined and a typing game is started.

While the music selection screen 15 is displayed on the first liquid crystal display 3, any given PV of musical compositions may be reproduced on the second liquid crystal display 4. Advertising images and others may also be provided. Further, the music selection screen 15 may be displayed not on the first liquid crystal display 3 but on the second liquid crystal display 4.

Next, an explanation will be made for contents displayed while a typing game is in progress by referring to FIGS. 3A-3B and 4A-4C. FIGS. 3A and 3B show the contents displayed on the first liquid crystal display 3 in which the predetermined musical composition ‘A’ performed by a male artist is selected on the music selection screen 15 to start the typing game. FIGS. 4A and 4B show the contents displayed on the second liquid crystal display 4 where the predetermined musical composition ‘B’ performed by a female artist is selected on the music selection screen 15 to start the typing game.

Here, FIG. 4C also shows, by way of example, the typing game with the same female artist, but with English lyrics thereof. Since the configuration other than the lyrics is the same, the duplicated explanation is omitted.

As shown in FIG. 3A, for example, where the musical composition ‘A’ is selected to start the game, a PV screen image 20 for the male artist who sings the musical composition ‘A’ reproduced via the speakers 8 is displayed on the second liquid crystal display 4. As shown in FIG. 4A, for example, where the musical composition ‘B’ is selected to start the game, the PV screen image 20 for the female artist who sings the musical composition ‘B’ reproduced via the speakers 8 is displayed on the second liquid crystal display 4.

On the other hand as shown in FIGS. 3B and 4B, a main game screen 21 related to the progress of the typing game is displayed on the first liquid crystal display 3, together with the display of the PV screen image 20 on the second liquid crystal display 4. The game procedures are similar with FIG. 4C.

In this instance, the main game screen 21 is constituted of a lyrics displaying part 22 which displays a phrase of the lyrics currently being performed in Chinese characters (Kanji), Japanese syllabary (Kana) and the like, a Roman character display part 23 which displays a character array 23A typed and entered by the player via the keyboard 6 in the Roman character (i.e., alphabet character), a musical-composition status displaying part 25 which displays what tune number (stage number) the phrase of the lyrics currently being displayed in the lyrics displaying part 22 belongs to and what number of the tune (or music) the phrase is in if counted from the beginning of the tune being performed, a type result displaying part 26 which displays the determination result of correct or incorrect typing by the player, a score displaying part 27 which displays scores, points and others so far acquired by the player and a music information displaying part 28 which displays the name of the artist and the music title now being performed.

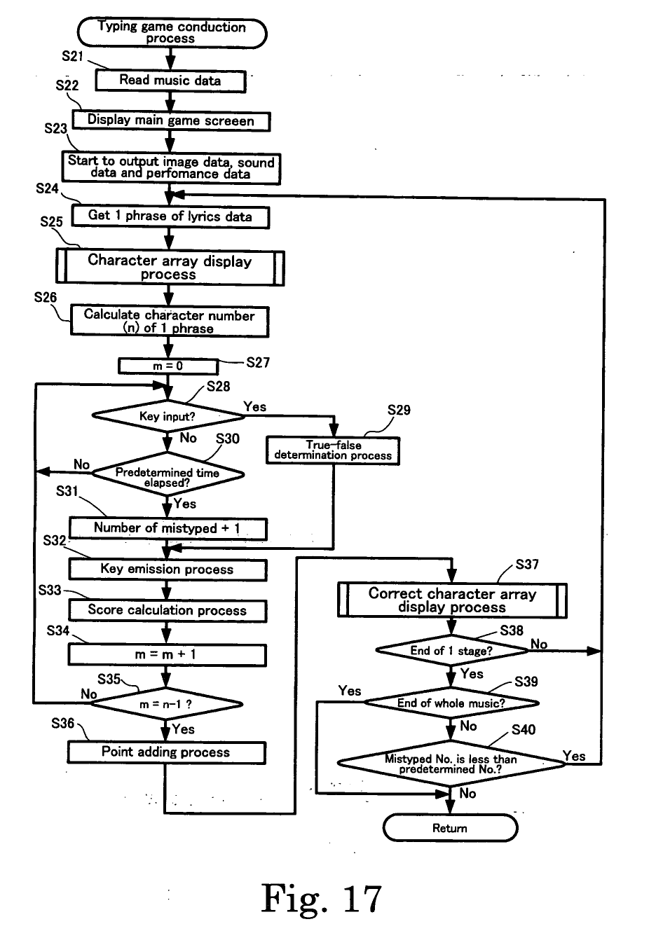

The lyrics displaying part 22 is a displaying part which displays the character array 22A corresponding to one phrase of the lyrics of the musical composition now being performed and the game proceeds as the player operates the keyboard 6 to type the character array 22A displayed in the lyrics displaying part 22. Then, scores are gradually added when the player correctly types the phrases of the lyrics displayed, whereas scores are not added when he or she erroneously types characters irrespective of the lyrics and the number of typing errors is also added as the number of erroneous entries. When the number of typing errors exceeds a predetermined number after completion of any tune number, among the tune numbers (stages) constituting the musical composition, the game is instantly terminated (refer to S40 in FIG. 17).

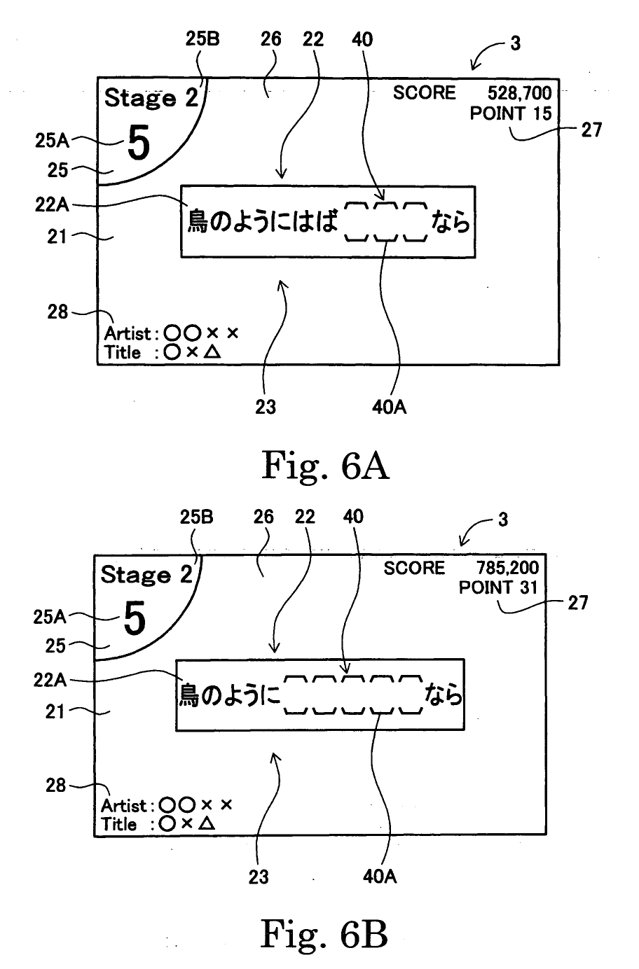

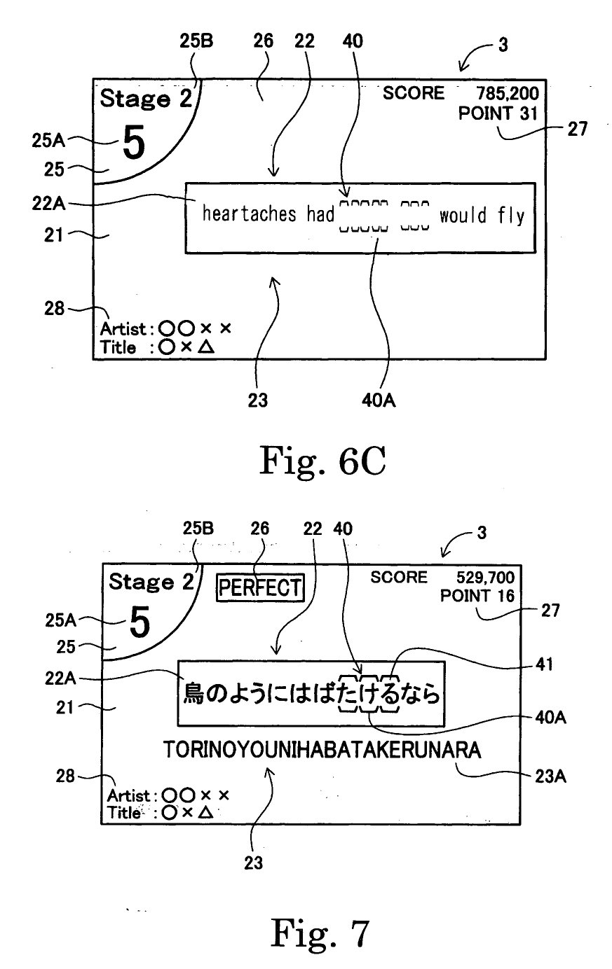

The character array 22A displayed in the lyrics displaying part 22 is partially displayed at any given timing in a state of being replaced by a blank character region 40 (a state in which no character array is displayed) (refer to FIGS. 6A and 6B). In this instance, the blank character region 40 is a special character array displaying mode in which brackets 40A the same in number with characters of the character array 22A to be displayed are displayed in sequence, thereby allowing the player to guess the correct characters of the lyrics corresponding to respective blank characters and prompting him or her to enter the correct characters. The blank character region 40 will be explained later in detail.

The Roman character display part 23 is a region for newly displaying the character array 23A already typed by the player in Roman characters among character arrays 22 corresponding to the lyrics displayed in the lyrics displaying part 22. It is, therefore, possible to notify a player of characters so far typed.

Here, as described above, in the current embodiment, special keys such as a conversion key for converting ‘kana’ into ‘kanji’ (plus ‘kana’ if any) are not included or evaluated in the typing game. Therefore, even though the conversion key (in most cases, space key) is entered after “TORI”, the conversion key is not shown there. Also, as shown in FIG. 4C, the space key entered between words may be counted (or evaluated) or may not be counted in the typing game with English text, for which the conversion key is not necessary. For example, there is easier for the player to recognize words if space is automatically placed between the words although the typed space is not evaluated as well as the automatically inserted space.

Here, the player actually types Roman characters (i.e., alphabets) corresponding to the phrase of the lyrics, but the player may enter ‘kana’ as shown on the keyboard (Refer to FIG. 10A). Also, it can be configured that the player can select either prior to the game. Further, it is also possible to let the player type space or a key corresponding to the pause mark (similar to comma) between segments (bunsetsu in Japanese). Such game conditions may be set with the typing game machine and the player can confirm or choose the conditions prior to the typing game. Now, it is possible to allow the player to enter the characters in either way if more than one ways can be used to type Roman characters to express the same Japanese characters (e.g., Hepburn system and other systems).

Further, the musical composition status displaying part 25 is to display what tune number the phrase of the lyrics currently being displayed in the lyrics displaying part 22 belongs to and what number of the tune the phrase is in if counted from the beginning of the tune being performed. In this instance, the typing game of the embodiment 1 is composed of a plurality of stages (for example, first to third stages) in accordance with the number of tune numbers of the musical compositions to be reproduced (for example, one musical composition is composed of tune numbers 1 to 3). For example, FIG. 3B now shows the 15th phrase of the first stage (tune number 1). Further, FIG. 4B now shows the 5th phrase of the stage 2 (tune number 2).

Then, a value 25A showing the phrase number is added one by one every time when entry of one phrase by a player is completed, and a value 25B showing the stage number (tune number) is added one by one every time when entry of one stage is completed. It is, therefore, possible to notify the player of the currently available stage number (tune number) and the phrase number so far completely typed.

The type result displaying part 26 is a part for displaying the determination result of correct or incorrect typing of the player, and when a corresponding correct character is typed at the same timing with the sound of the performed musical composition, “PERFECT” is displayed. Further, when a correct character is typed not at the same timing as the corresponding sound of the musical composition is performed, “GOOD” is displayed. On the other hand when a wrong character is typed irrespective of the timing of the sound, “MISS” is displayed.

The score displaying part 27 is a part for displaying the scores and points so far acquired by the player. In this instance, the score is added when characters are correctly typed according to the character array 22A displayed at the lyrics displaying part 22. Further, when the corresponding character is typed at the same timing as the corresponding sound of the musical composition is performed, an additional score is acquired. On the other hand one point is added every time when one phrase is typed completely without any typing errors (S36 in FIG. 17).

Then, the number of blank characters (the number of non-displayed characters) at the blank character region 40 displayed by the lyrics displaying part 22 is varied, as described later, depending on whether or not the number of points so far acquired reaches a predetermined percentage in relation to the phrase number so far completely typed (refer to FIG. 9). To be more specific, an increased number of non-displayed characters is given to the player having a higher point acquisition rate (correct answer rate) to raise the degree of difficulty in the game, and a decreased number of non-displayed characters is given to the player having a lower point acquisition rate (correct answer rate) to reduce the degree of difficulty in the game. It is, therefore, possible to conduct the game according to the level of the player, thereby improving his or her willingness to play the game.

Further, the scores and points are added until completion of the game, and where an IC card is inserted into the card insertion slot 10 of the center panel 5, the scores and points acquired upon completion of the game are stored in the IC card (S9 in FIG. 15).

In addition, the music information displaying part 28 displays the title of a musical composition and the name of an artist which is selected by a player at the time of starting the game and now being performed.

In the embodiment 1, the main game screen 21 is to be displayed on the first liquid crystal display 3, and the PV screen image 20 is to be displayed on the second liquid crystal display 4. However, in contrast, the PV screen image 20 may be displayed on the first liquid crystal display 3 and the main game screen 21 may be displayed on the second liquid crystal display 4.

Then, as shown in FIG. 5, after completion of the typing game, a game result screen 30 showing the result of the current typing game is displayed on the first liquid crystal display 3.

The game result screen 30 is composed of a typing-error number displaying part 31 which displays the number of typing errors made in the current typing game, an acquisition point displaying part 32 which displays acquired points, an acquisition score displaying part 33 which displays acquired scores and a name entry displaying part 34 which prompts the game player to enter his or her name.

Then, by referring to the game result screen 30, the player knows the number of typing errors made in the current typing game and the acquired points and scores. Further, the player uses the keyboard 6 to enter any given name into the name entry displaying part 34, thereby making it possible to register the acquired scores in the ranking. A list of the thus registered ranking is displayed on the first liquid crystal display 3 or the second liquid crystal display 4 as a demonstration screen or the like.

Further, while the game result screen 30 is displayed on the first liquid crystal display 3, the PV of any given musical composition may be provided on the second liquid crystal display 4. Images for advertisement and the like may also be displayed. In addition, the game result screen 30 may be displayed not on the first liquid crystal display 3 but on the second liquid crystal display 4.

Next, an explanation will be made in referring to FIGS. 6A-6C, 7-9 for a blank character region 40 which is displayed at any given time in the lyrics displaying part 22 and in which the character array 22A is partially non-displayed. First, an explanation will be made in referring to FIGS. 6A-6C and 7 for a displaying mode of the blank character region 40 displayed while a typing game is in progress on the first liquid crystal display 3. FIG. 6A is a pattern diagram showing the contents displayed on the first liquid crystal display 3 upon display of the blank character region 40 where the number of blank characters is set to be 3. FIG. 6B shows the general contents displayed on the first liquid crystal display 3 upon display of the blank character region 40 where the number of blank characters is set to be 5. FIG. 6C shows the general contents if the lyrics are in English. FIG. 7 shows general contents displayed on the first liquid crystal display 3 at the completion of typing one phrase when the blank character region 40 is shown.

As shown in FIGS. 6A-6C, the character array 22A displayed in the lyrics displaying part 22 is partially replaced by the blank character region 40 at any given timing for display. In the blank character region 40, three or five brackets 40A are arranged in a line, and the player guesses a character array which may correspond to the correct phrased of the lyrics from the number of brackets 40A displayed in a line and enters characters according to the guessed character array. Further, a musical composition to be performed is controlled so that the sound of the phrase of the lyrics corresponding to the blank character region 40 is outputted only when characters of the correct phrase of the lyrics (for example, character array 41 shown in FIG. 7) are entered. Unless the player memorizes the lyrics of the musical composition to be performed, he or she cannot type the correct character array and let the speaker reproduce the sound of the corresponding phrase of the lyrics, thereby making it possible to enhance his or her desire to play the game.

First, in this instance, as shown in FIG. 6A, an explanation will be made for the blank character region 40 being composed of three blank characters. The blank character region 40 is constituted by three brackets 40A arranged in a line next to another character array 22A.

Then, when the player types characters for entry on the basis of the displayed main game screen 21, a determination is made for whether the characters are typed correctly or not similarly when an ordinary typing game is conducted, and the entered character array 23A is displayed in the Roman character display part 23. At the time when all the displayed character array corresponding to one phrase of the lyrics has been completely entered, as shown in FIG. 7, a character array 41 to be entered which corresponds to the phrase of the lyrics of the musical composition to be performed is displayed inside each brackets 40A at the blank character region 40. Therefore, the player recognizes correct lyrics to be entered.

Next, as shown in FIG. 6B, an explanation will be made for the blank character region 40 being composed of five blank characters. The blank character region 40 is composed of five brackets 40A arranged in a line next to another character array 22A.

Then, when the player types characters, a determination is made for whether the characters are typed correctly or not similarly to when an ordinary typing game is conducted, and the character array 23A entered is displayed at the Roman character display part 23. At the time when all the displayed character array corresponding to one phrase of the lyrics has been completely entered, although not illustrated, a character array 41 to be entered which corresponds to the phrase of the lyrics of the musical composition to be performed is displayed inside each brackets 40A in the blank character region 40, as in case of the blank character region 40 being composed of three blank characters.

Next, as shown in FIG. 6C, an explanation will be made for the blank character region 40 being composed of five blank characters and three blank characters. The blank character region 40 is composed of five and three brackets 40A arranged in a line next to another character array 22A.

Then, when the player types characters, a determination is made for whether the characters are typed correctly or not similarly to when an ordinary typing game is conducted, and the character array 23A entered is displayed in the Roman character display part 23. At the time when all the displayed character array corresponding to one phrase of the lyrics has been completely entered, although not illustrated, a character array to be entered which corresponds to the phrase of the lyrics of the musical composition to be performed is displayed inside each brackets 40A in the blank character region 40, similarly with the case of the blank character region 40 being composed of three blank characters (FIG. 7).

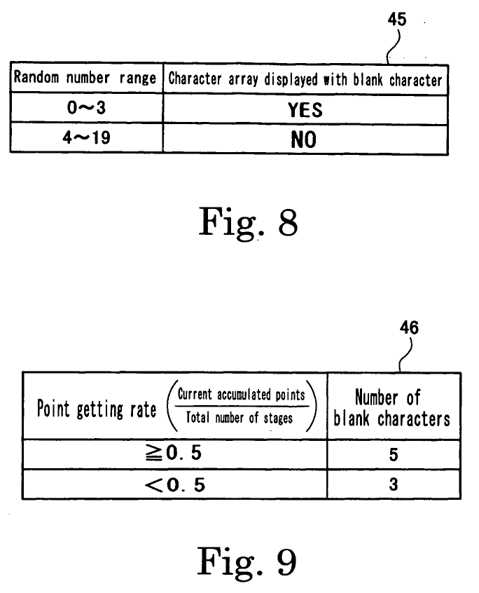

Further, an explanation will be made in referring to FIG. 8 for a replacement lottery table 45 which is used when a determination is made for whether or not the character array 22A is partially replaced by the blank character region 40 to be displayed. FIG. 8 is a drawing showing the replacement lottery table 45 related to the embodiment 1.

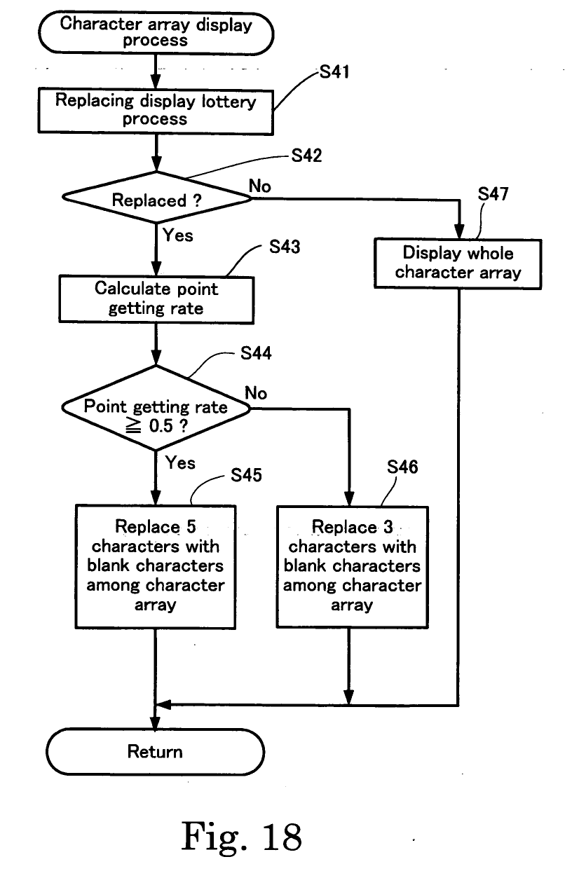

The replacement lottery table 45 is a lottery table for drawing lots on the basis of random number values sampled by the random number sampling circuit 73 for displaying the displayed character array 22A while the typing game in progress is partially replaced by the blank character region 40. To be more specific, a lottery is held by using the replacement lottery table 45 every time when a new phrase is displayed (refer to S41 in FIG. 18). As shown in FIG. 8, where the random number value is in the range from 0 to 3, the character array 22A of the thus displayed phrase is partially replaced by the blank character region 40 for display (refer to FIGS. 6A-6C). Meanwhile, where the random number value is in the range from 4 to 19, the whole character array 22A corresponding to the phrase of the lyrics is displayed as usual, without displaying of the blank character region 40 (refer to FIGS. 3B and 4B-4C). The replacement lottery table 45 is stored in a ROM 53 to be described later (refer to FIG. 13).

Further, with reference to FIG. 9, an explanation will be made for a blank character number determination table 46 used in determining the number of these blank characters (number of non-displayed characters) where the blank character region 40 is displayed. FIG. 9 is a drawing to show the blank character number determination table 46 of the embodiment 1.

The blank character number determination table 46 is a table for determining the number of blank characters at the blank character region 40 on the basis of a point acquisition rate (correct answer rate) when the displayed character array 22A while the typing game in progress is partially replaced by the blank character region 40 for display. In this instance, the point acquisition rate is a value obtained by dividing “current point number obtained by the player” by “total stage number played so far in the present game.” As described previously, one point is added every time when a sentence covering one phrase is completely entered without any typing errors, and the point acquisition rate is a value showing a correct answer rate of a player who types phrases without typing errors.

Then, in the typing game machine 1 of the embodiment 1, when a determination that the replacement lottery table 45 is used to display the blank character region 40 is made, the blank character number determination table 46 is used to determine the number of the blank characters (refer to S44 in FIG. 18). To be more specific, as shown in FIG. 9, where the acquisition rate (correct answer rate) of points at the time concerned exceeds 0.5, the number of blank characters (number of characters to be non-displayed) is set to be five characters. Further, where the acquisition rate (correct answer rate) of points is less than 0.5, the number of blank characters (number of characters to be non-displayed) is set to be three characters. Therefore, an increased number of non-displayed characters is given to a player having a higher point acquisition rate (correct answer rate) to raise the degree of difficulty in a game, and a decreased number of non-displayed characters is given to a player having a lower point acquisition rate (correct answer rate) to reduce the degree of difficulty in a game. It is, therefore, possible to conduct a game according to the level of a player, thereby enhancing the desire of the player to play the game. The blank character number determination table 46 is stored in a ROM 53 to be described later (refer to FIG. 13).

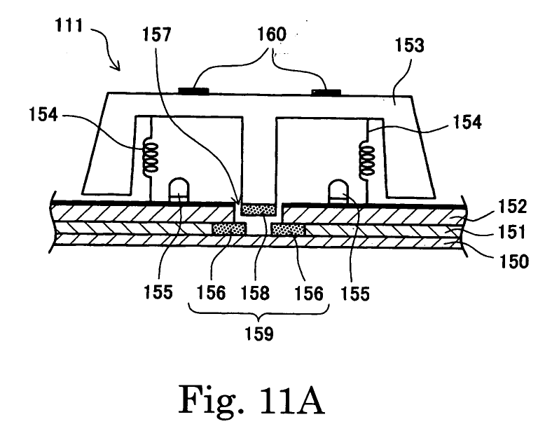

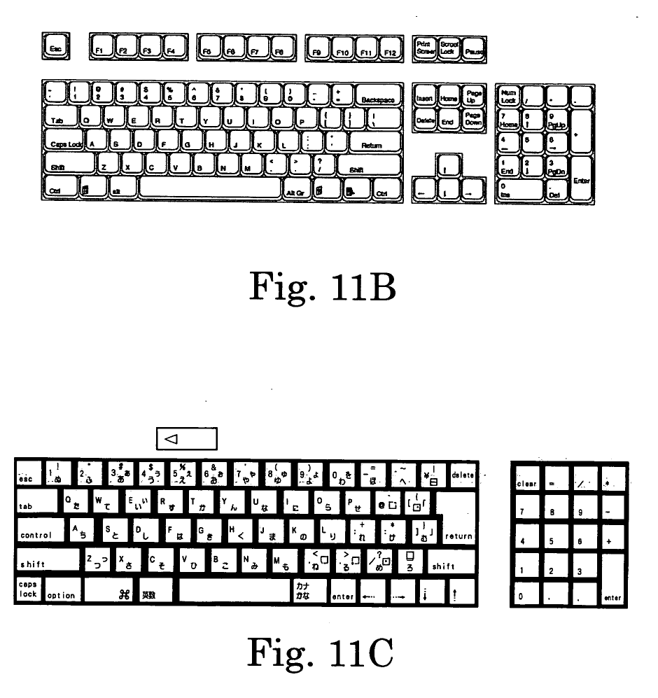

Then, an explanation will be made for the keyboard 6 provided in the typing game machine 1 by referring to FIG. 10 and FIG. 1A. FIG. 10 is a plain view showing the keyboard provided in the typing game machine of the embodiment 1. FIG. 11A is a schematic cross sectional view showing the cross section of any one of a plurality of keys provided on the keyboard.

Here, by way of example, other keyboards are shown in FIGS. 11B and 11C.

As shown in FIG. 10, the keyboard 6 is a Japanese language keyboard 108 in which a plurality of character enter keys 111 for entering “alphabetic letters (A to Z),” “Japanese syllabary (‘a’ to ‘n’),” “numerals (0 to 9)” and “symbols (period and comma)” as well as function keys 115 such as an enter key 112, a shift key 113 and cursor keys 114 are individually arranged. Then, while a game is in progress, a player types the character enter keys 111 corresponding to characters, symbols, numerals and others, thereby entering characters to advance the game. Further, prior to starting the game or after completion of the game, the player gives instructions to select and decide a musical composition for the game or the degree of difficulty or to start and execute the game by operating the function key 115. Light-emitting diodes are provided inside each of the keys on the keyboard 6, and the keys are constituted so as to emit light in various modes according to control signals provided from a CPU 51.

In this instance, an explanation will be made for the inner structure of the keyboard 6 by referring to FIG. 1A. The keys arranged on the keyboard 6 are all identical in inner structure. Hereinafter, an explanation will be made by referring to the inner structure of one character enter key 111 among a plurality of keys arranged on the keyboard 6, and an explanation will be omitted for the rest of the character enter keys 111 and the function keys 115.

As shown in FIG. 11A, the character enter key 111 is basically composed of a base plate 150, a switch circuit plate 151, a light-emitting circuit plate 152, a key top 153, an energizing mechanism 154, a full-color LED 155 and others.

In this respect, the switch circuit plate 151 arranged on the base plate 150 is provided with a pair of electrodes 156 disposed approximately below the center of the key top 153.

Further, the light-emitting circuit plate 152 attached on the switch circuit plate 151 is provided with an opening 157 for exposing a pair of electrodes 156, and the full-color LED 155 capable of lighting in a full color is provided around the opening 157.

The energizing mechanism 154 is provided between the light-emitting circuit plate 152 and the key top 153, and applies energy on key top 153 to the opposite side of the switch circuit plate 151 by the energizing mechanism 154. In addition, an electrode 158 is projected toward the switch circuit plate 151 approximately at the center of the key top 153. Since the electrode 158 projected on the key top 153 can be brought into contact with the a pair of electrodes 156 provided on the switch circuit plate 151 by depressing the key top 153, depression of the key top 153 can be transmitted as an electrical signal flowing through the switch circuit plate 151. That is, a key switch 159 is composed of these three electrodes 156 and 158.

The energizing mechanism 154 may be composed of an elastic body alone or with an elastic body and cross-linking mechanism. There is no particular restriction on the constitution.

Further, the key top 153 is formed with translucent materials (for example, transparent acryl and transparent plastic materials), and key information 160 such as characters, numerals and symbols are printed in black at the flat part on the surface. The surface of the light-emitting circuit plate 152 facing the key top 153 is also printed in black.

While the full color LED 155 is not lit, the translucent key top 153 is reflected in black which is a surface color of the light-emitting circuit plate 152. It is, therefore, difficult to recognize the key information 160 which is printed in black on the key top 153 reflected in black.

On the other hand while the full color LED 155 is lit, the translucent key top 153 is reflected in a lighting color derived from the full color LED 155. Therefore, the key information 160 which is printed in black on the key top 153 reflected in the lighting color can be easily recognized.

Then, in the keyboard 6a key switch 159 inside each key is connected to a signal sending circuit (not illustrated). The signal sending circuit is connected via an interface unit 52 to be described later (hereinafter, abbreviated as I/O) to the CPU 51 of the typing game machine 1. Therefore, when an electric signal from the key switch 159 depressed by the key is sent via the signal sending circuit to the CPU 51, it is possible to identify the type of depressed key. The signal sending circuit is loaded on the switch circuit plate 151.

Further, in the keyboard 6, the full color LED 155 inside the key is connected to an emission control circuit 62. The emission control circuit 62 is connected to the CPU 51 via the I/O 52 (refer to FIG. 13). It is, therefore, possible to light on the full color LED 155 inside the key in a color specified by the CPU 51 via the emission control circuit 62. To be more specific, where it is determined that key entry is made and determined that a correct typing is performed while a typing game is in progress in typing game machine 1 of the embodiment 1, the character enter key 111 is emitted in a blue color upon depression. Where it is determined that key entry is made and determined that an erroneous typing is performed, the character enter key 111 is emitted in a red color upon depression and a correct key to be entered is emitted in a green light. Further, where no key entry is made, only a correct key to be entered is emitted in a green color.

As shown in FIG. 12, the typing game machine 1 of the embodiment 1 is connected to a server 80 via a network N which can bi-directionally communicate such as the Internet. Then, the typing game machine 1 is able to update music data stored in the HDD 55 of the gaming machine 1 on the basis of the data sent from the data server 80 (refer to FIG. 13).

It is, therefore, possible to change types of musical composition which can be played in the typing game machine 1 by updating the music data. It is also possible to easily update the data by comprehensively controlling typing game machines installed at game shops.

Next, an explanation will be made for the constitution related to a control system of the typing game machine 1 by referring FIG. 13. FIG. 13 is a block diagram graphically showing the control system of the typing game machine of the embodiment 1.

As shown in FIG. 13, the control system of the typing game machine 1 is composed of a CPU 51 which controls game processing operations and others in the typing game machine 1, a ROM 53 and a RAM 54 connected to the CPU 51 and a peripheral unit (actuator) electrically connected to the CUP 51.

The CPU 51 is a central processing unit which conducts computing processes according to various commands. The I/O 52 is a part which electrically connects the CPU 51 with the liquid crystal display 3, the second liquid crystal display 4, the keyboard 6, the external illumination LEDs 7, the speakers 8 and others directly or indirectly. The ROM 53 is a non-volatile read-only memory which accommodates computing programs and others for actuating the replacement lottery table 45 (refer to FIG. 8), the blank character number determination table 46 (refer to FIG. 9) and a flow chart to be described later.

Further, the RAM 54 is a memory for temporarily storing various data computed at the CPU 51 and also storing the number of typing errors made by a player in the current typing game, acquired scores, acquired points, the number of total stages so far played by a player and others. In addition, among a plurality of music data stored in the HDD 55 to be described later, lyrics data of the music data used in the current typing game is divided into each phrase and temporarily stored in the RAM 54.

The HDD 55 is a storage unit which accommodates music data used when a typing game is conducted in the typing game machine 1. In this instance, the music data includes screen image data, performance data, audio data, lyrics data, determination criterion data, LED emission pattern data, keyboard emission pattern data and time-limit data, which is stored in individual storage areas of a music data storage area 56 formed inside the HDD 55 (refer to FIG. 14).

Further, the music data is stored in plurality (up to 8 in the embodiment 1) in the music data storage area 56. As described previously, individual music data stored on the basis of data sent from a data server 80 is updated, whenever necessary. Then, types of music titles displayed on the music selection screen 15 (refer to FIG. 2) are changed on the basis of types of music data stored in the data music data storage area 56, and a typing game is conducted according to the music data corresponding to musical compositions selected by the music selection screen 15 (refer to FIGS. 3A-3B and 4A-4C).

In this instance, a more detailed explanation will be made by referring to FIG. 14 for the music data storage area 56 provided in the HDD 55. FIG. 14 is a drawing for graphically explaining the music data storage area.

As shown in FIG. 14, the music data storage area 56 of the typing game machine 1 in the embodiment 1 is composed of a plurality of storage areas (a first storage area to an eighth storage area in the embodiment 1) corresponding to the number of storable music data (8 musical compositions in the embodiment 1). Each storage area is provided with a screen image data storage area 56A, a performance data storage area 56B, an audio data storage area 56C, a lyrics data storage area 56D, a determination criterion data storage area 56E, an LED emitting pattern data storage area 56F, keyboard emitting pattern data storage area 56G and a time-limit data storage area 56H.

Hereinafter, an explanation will be made for each storage area. The screen image data storage area 56A is a storage area which stores screen image data on a PV screen image 20 of an artist displayed on the second liquid crystal display 4, among the music data (refer to FIGS. 3A and 4A).

The performance data storage area 56B is a storage area which stores performance data on instrumental accompaniment output from the speakers 8 among the music data.

Further, the audio data storage area 56C is a storage area which stores audio data on a singing voice sung by an artist output from the speakers 8 among the music data.

In addition, the lyrics data storage area 56D is a storage area which stores lyrics data on document data of musical composition lyrics among the music data. The lyrics data are recorded also for a range of character arrays being composed of three and five characters (for example, “TA KE RU” and “HA BA TA KE RU”) as phrases given in FIGS. 6A and 6B) replaced by the blank character region 40 for each phrase. Then, as described previously, when a typing game is conducted, lyrics prepared for each one phrase are displayed on the first liquid crystal display 3 (refer to FIGS. 3B and 4B).

Then, the determination criterion data storage area 56E is a storage area which stores determination criterion data on criteria for whether or not a player types characters correctly and at a correct timing while a typing game is in progress, among the music data. The CPU 51 adds the number of typing errors, scores, points and others on the basis of the stored determination criterion data and operation signals from the keyboard 6.

The LED emitting pattern data storage area 56F and the keyboard emitting pattern data storage area 56G are storage areas which store LED emitting pattern data for emitting the external illumination LEDs 7 and keyboard emitting pattern data for emitting a full color LED 155 installed inside the key, among the music data. In the typing game machine 1 of the embodiment 1, these eight external illumination LEDs 7 are controlled so as to provide individual light-emitting modes (for example, emission color, lighting on and lighting off) by an emission control circuit 62 to be described later while a typing game is in progress on the basis of the stored LED emitting pattern data. Further, the full color LED 155 provided inside the key is controlled so as to provide individual light-emitting modes (for example, emission color, lighting on and lighting off) by the emission control circuit 62 to be described later while a typing game is in progress on the basis of the stored keyboard emitting pattern data. Light-emitting patterns of the full color LED 155 include a light-emitting pattern for a beginner of a typing game in which key entry is assisted by lighting on the key to be entered in sequence in an illumination color different from that of a whole of the keyboard 6 and a pattern in which all the keys arranged on the keyboard 6 are changed in illumination color in accordance with an image of the musical composition concerned.

The time-limit data storage area 56H is a storage area which stores time-limit data on the expiration date of music data among the music data, and the time-limit data includes data of two dates, namely, the date when the music data is usable (use commencement date) and the date when the music data becomes unusable (use completion date). The time-limit data becomes used in controlling the expiration date of individual music data, together with a timer 58 (refer to FIG. 13), and the CPU 51 controls so that no typing game can be played by using the music data, the date of which is expired.

FIG. 4C shows an example with English lyrics. Since the configuration is similar to that in FIG. 4B, a duplicated explanation is omitted. The lyrics data storage area 56D as shown in FIG. 14 is a storage area which stores the lyrics data on document data of musical composition lyrics among the music data. The lyrics data are recorded also for a range of character arrays being composed of three and five characters (for example, “WINGS” and “SHE”) as phrases given in FIG. 6C replaced by the blank character region 40 for each phrase. Then, as described previously, when a typing game is conducted, lyrics prepared for each one phrase are displayed on the first liquid crystal display 3 (refer to FIGS. 3B and 4B-4C).

In this instance, an explanation will be made for the control system of the typing game machine 1 by referring to FIG. 13 again.

The game communications means 57 is a unit in which signals sent from the typing game machine 1 are converted to transmittable signals according to communications forms such as telephone lines and LAN cables, and sent to a server 80, signals sent from the server 80 are received and converted again to signals that can be read by the typing game machine 1. This unit is connected via the network N which can bi-directionally communicate such as a server communications means 81 of the server 80 and the Internet (refer to FIG. 12).

Further, a timer 58 is connected to the CPU 51. Information on the timer 58 is sent to the CPU 51, and the CPU 51 controls the expiration date of stored music data by referring to the information on the timer 58 and the time-limit data stored in the time-limit data storage area 56H of the HDD 55.

The CPU 51 is connected to a clock pulse generating circuit 70 which generates a reference clock pulse and to a frequency divider 71. It is also connected to a random number generator 72 which generates random numbers and to a random number sampling circuit 73. Random numbers sampled via the random number sampling circuit 73 are used in various lotteries such as replacement determination by the blank character region 40 (refer to S42 in FIG. 18).

Further, a display control circuit 60 is connected to the CPU 51 via the I/O 52 and controls the contents displayed by the first liquid crystal display 3 and the second liquid crystal display 4, according to computing processing results of the CPU 51. In this instance, the display control circuit 60 is composed of a program ROM, an image ROM, an image control CPU, a work RAM, a VDP (video display processor), a video ROM and others. Then, the program ROM accommodates image control programs on display by the first liquid crystal display 3 and the second liquid crystal display 4 as well as various selection tables. Further, the image ROM accommodates dot data for forming various images, for example, a music selection screen 15 (refer to FIG. 2), a main game screen 21 (refer to FIGS. 3A to 4C) and a game result screen 30 displayed on the first liquid crystal display 3.

Then, the image control CPU decides an image displayed on the first liquid crystal display 3 and the second liquid crystal display 4 from the dot data stored in advance in the image ROM according to the image control program in advance stored in the program ROM on the basis of parameters set by the CPU 51. Additionally, the VDP forms an image according to display contents determined by the image control CPU, outputting the image on the first liquid crystal display 3 or the second liquid crystal display 4.

Therefore, for example, in a standby state, demonstration screens including PV of any given musical composition, advertisement and a ranking list are displayed. After coins are inserted into the coin insertion slot 9, the music selection screen 15 is displayed on the first liquid crystal display 3 (refer to FIG. 2). Then, when a typing game is started and conducted in the typing game machine 1, control is given, for example, lyrics data which constitute music data are displayed for each phase on the first liquid crystal display 3, and the character array 23A already typed by a player on the basis of the entered result of the keyboard 6 is displayed at the Roman character display part 23. Further, where it is determined that the blank character region 40 is partially replaced by the character array 22A for display on the basis of lottery results, the blank character region 40 being composed of a plurality of brackets 40A is displayed at the lyrics displaying part 22 in place of the character array (refer to FIGS. 6A-6C). On the other hand PV which is screen image data constituting music data is displayed on the second liquid crystal display 4.

A sound control circuit 61 is connected to the CPU 51 via the I/O 52, and also to the speakers 8. Then, when a typing game is conducted and music data stored in a music data storage area 56 of the HDD 55 is read out, performance data and audio data constituting the music data are converted to sound signals by the sound control circuit 61 and output from the speakers 8.

Then, an emission control circuit 62 is connected to the CPU 51 via the I/O 52 and also connected to the external illumination LEDs 7 and the full color LED 155 disposed inside the key (refer to FIG. 1A). When music data stored in the music data storage area 56 of the HDD 55 are read out by the CPU 51, the emission control circuit 62 controls light emitting modes of the external illumination LEDs 7 and the full color LED 155 on the basis of LED emitting pattern data and keyboard emitting pattern data constituting the music data.

Further, the CPU 51 is connected to the keyboard 6. A key switch 159 provided inside each key of the keyboard 6 sends the fact that the key top 153 is depressed as an electrical signal flowing through the switch circuit plate 151. The CPU 51 controls to execute various operations corresponding to each key on the basis of a switch signal output from each of the key switch 159 upon depression of the keys.

The coin sensor 63 is a sensor for detecting coins (for example, 100 yen coins) used as a value in conducting a typing game in the typing game machine 1. The coin sensor 63 is disposed inside a coin insertion slot 9 and connected to the CPU 51 via the I/C 52. Therefore, the coin sensor 63 sends a coin insertion signal to the CPU 51 on the basis of coins inserted into the coin insertion slot 9. Then, the CPU 51 detects the coin insertion signal corresponding to a predetermined amount (for example, 200 yen), thereby allowing to play the typing game.

Further, the card sensor 64 is also a sensor for detecting whether an IC card is inserted into the card insertion slot 10 or not, and the card reader/writer 65 is a unit for reading and writing an IC tag disposed on the IC card. The card sensor 64 and the card reader/writer 65 are disposed inside the card insertion slot 10 and connected to the CPU 51 via the I/O 52. Then, when the IC card is detected by the card sensor 64 and a predetermined operation is conducted, the card reader/writer 65 reads the result of a typing game from the IC tag (S3 in FIG. 15). When the typing game is completed, new game results (acquired scores and points) are written into the IC tag (S9 in FIG. 15).

Then, an explanation will be made for main processing programs carried out in the typing game machine 1 having the above-described constitution by referring to FIG. 15. FIG. 15 is a flow chart showing the main processing programs for the typing game machine 1 of the embodiment 1. Individual programs of the flow charts given in FIGS. 15 to 19 are stored in the ROM 53 and the RAM 54 provided in the typing game machine 1 and carried out by the CPU 51.

As shown in FIG. 15, first, the CPU 51 detects whether an IC card is inserted into the card insertion slot 10 or not on the basis of a detection signal sent from the card sensor 64. Then, where it is determined that the IC card is inserted thereinto (S1: Yes), a determination is made in S2 for whether confirmation of data contents is requested by a player or not. On the other hand where it is determined that no IC card is inserted (S1: No), the typing game machine 1 proceeds to S4.

In the typing game machine 1 of the embodiment 1, when a shift key 113 of the keyboard 6 is depressed before coins are inserted and in a state that the IC card owned by a player is kept inserted into the card insertion slot 10, a list of game results stored in the IC card (scores, points and others so far acquired by the player) is displayed on the first liquid crystal display 3, from which the player is able to confirm the contents.

Therefore, in S2, a determination is made for whether the shift key 113 is depressed or not on the basis of an operation signal from the keyboard 6 and it is determined that the shift key 113 is depressed (S2: Yes), the card reader/writer 65 reads IC tag data built in the IC card, thereby displaying the list of game results on the first liquid crystal display 3 on the basis of the thus read data (S3).

Further, a start reception process is carried out in S4. To be more specific, in the start reception process, a determination is made for whether coins (100 yen coins and others) are inserted into the coin insertion slot 9 or not in a predetermined amount (200 yen in the embodiment 1). Until such insertion is made, a standby state is kept in which a game screen for demonstration play and a demonstration screen for PV of any given musical composition, advertisement and list of ranking data are displayed. Further, in the typing game machine 1 of the embodiment 1, when coins are inserted into the coin insertion slot 9, the coin sensor 63 detects the fact and sends a coin detection signal to the CPU 51, by which the CPU 51 can determine that coins have been inserted by a player.

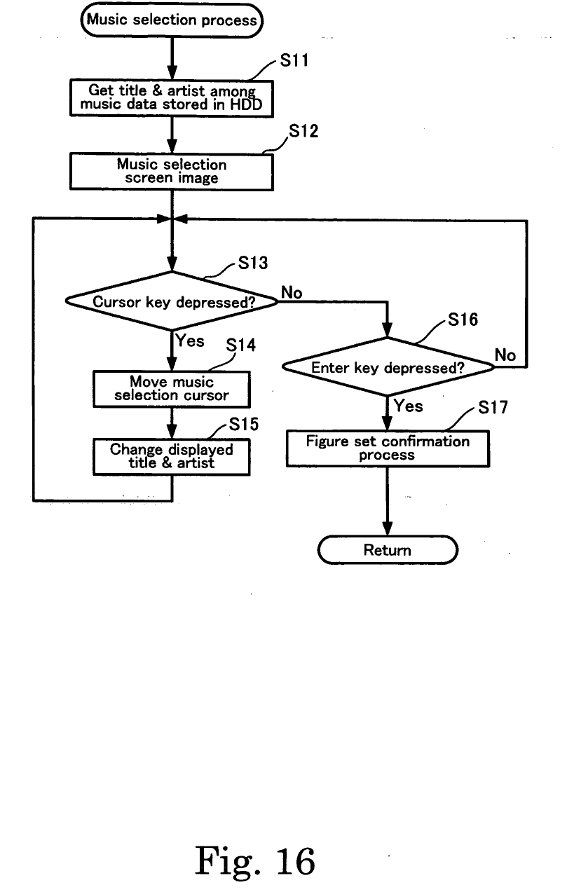

Then, in S5, a musical composition selection process is carried out as shown in FIG. 16. In the musical composition selection process, as described later, the music selection screen 15 (refer to FIG. 2) is displayed on the first liquid crystal display 3 according to a type of music data stored in the music data storage area 56 of the HDD 55, thereby setting the musical composition to be used in the current game.

Then, in S6, a typing game conduction process is carried out according to a musical composition set in the S5, as shown in FIG. 17. As is explained later, in the typing game conduction process, the musical composition is performed and scores, points and others are added on the basis of typing results of the keyboard 6 to continue a typing game until predetermined completion requirements are met.

Thereafter, when the typing game conduction process is completed, a game result display process is carried out (S7). To be more specific, in the game result display process, the game result screen 30 (refer to FIG. 5) is displayed on the first liquid crystal display 3 on the basis of the typing game of the S6. The number of typing errors made in the current typing game and stored in the RAM 54 as well as acquired points and scores are individually displayed on the game result screen 30. A name entry displaying part 34 which prompts a player to enter his or her name is also displayed. Further, when the keyboard 6 is operated, while the above state kept as it is, characters entered into the name entry displaying part 34 are displayed on the basis of the operation signal. Then, where acquired scores are more than the predetermined scores, the ranking data stored in the RAM 54 is updated.

Next, in S8, the CPU 51 makes a determination on whether an IC card is inserted into the card insertion slot 10 by referring to a detection signal from the card sensor 64. Further, where it is determined that the IC card is inserted (S8: Yes), in S9, the points and scores acquired in the current typing game and stored into the RAM 54 are individually written into an IC tag built-in the IC card by the card reader/writer 65. The thus written data can be referred to by the data content displaying process in the S3.

On the other hand where it is determined that no IC card is inserted (S8: No), the process is completed.

Further, an explanation will be made by referring to FIG. 16 for musical composition selection processing programs of the S5 carried out in the typing game machine 1. FIG. 16 is a flow chart of the musical composition selection processing programs of the embodiment 1.

In the musical composition selection process, first, in S11, music titles and artist names of musical compositions (up to 8 in the embodiment 1) on stored music data are individually obtained from the music data storage area 56 of the HDD 55.

Then, the music selection screen 15 (refer to FIG. 2) is displayed on the first liquid crystal display 3 according to music titles and artist names of the musical compositions obtained in the S11 (S12). In the music selection screen 15, titles of musical composition obtained in the playable music title displaying part 16 are enlisted and displayed. Further, the music titles and artist names of musical compositions selected by the music selection cursor 17 are displayed respectively at the selected music title displaying part 18 and the selected artist name displaying part 19.

Further, in S13, a determination is made for whether the cursor key 114 is depressed or not. In this instance, whether the cursor key 114 is depressed or not is determined by referring to an operation signal sent from the keyboard 6. Where it is determined that the cursor key 114 is depressed (S13: Yes), a music selection cursor 17 displayed on the first liquid crystal display 3 is moved toward the depressed direction on the basis of the operation of the cursor key 114 (which key is depressed, of the left, right, up and down ones) (S14).

In addition, in S15, the display of the selected music title displaying part 18 and that of the selected artist name displaying part 19 are changed respectively to the music title and the artist name corresponding to the musical composition selected by the music selection cursor 17 moved in the S14. Thereafter, the typing game machine returns to a determination process in S13.

In contrast, where it is determined that the cursor key 114 is not depressed (S 13: No), a determination is continuously made for whether the enter key 112 is depressed or not in S16. Then, where it is determined that the enter key 112 has been depressed (S16; Yes), the musical composition on which the music selection cursor 17 is now located is set to be a musical composition played in the current typing game (S17), and a typing game to be described later is started. On the other hand where it is determined that the enter key 112 has not been depressed (S16: No), the typing game machine again returns to the determination process in S13.

Then, an explanation will be made by referring to FIG. 17 for a typing game conduction process program carried out by the typing game machine 1 in the S6. FIG. 17 is a flow chart showing the typing game conduction process program for the embodiment 1.

In the typing game conduction process, first, the CPU 51 reads out music data corresponding to the musical composition selected by the musical composition selection process in the S5, among music data stored at each storage area (refer to FIG. 14) of the music data storage area 56 of the HDD 55 in S21. Then, in particular, lyrics data accommodated in the lyrics data storage area 56D are divided into each phrase and temporarily stored in the RAM 54.

Next, the main game screen (refer to FIGS. 3B and 4B) is displayed on the first liquid crystal display 3 in S22. At this moment, a character array is not displayed at the lyrics displaying part 22 or at the Roman character display part 23, and the points and score of the score displaying part 27 is displayed as “zero.”

In S23, the PV screen image 20 of the musical composition selected on the second liquid crystal display 4 is started to be displayed on the basis of the screen image data stored in the screen image data storage area 56A (refer to FIGS. 3A and 4A). Further, music for accompaniment is output on the basis of performance data stored in the performance data storage area 56B and voice is output on the basis of audio data stored in the audio data storage area 56C individually via the speakers 8, by which the musical composition is performed and the PV screen image 20 is reproduced accordingly.

Next, in S24, lyrics equivalent to one phase of the lyrics data accommodated in the RAM 54 is obtained. The character array 22A corresponding to the thus obtained lyrics data is subjected to a character array display process displayed at the lyrics displaying part 22 of the main game screen 21 as shown in FIG. 18 (S25). In the character array display process, as described later, a lottery process is carried out in which a determination is made by lottery for whether the character array 22A is partially replaced by the blank character region 40 for display or not (whether the character array is partially non-displayed or not). The character array 22A and the blank character region 40 are displayed according to the lottery result.

Thereafter, in S26, the number of characters for one phrase, n, is calculated on the basis of the one-phrase lyrics data obtained in the S24 and zero is assigned to any given variable m accommodated in the RAM 54 (S27). In this instance, any given variable m is a variable used in entry determination for a character corresponding to each character constituting one phrase and a variable is added by one each time when an entry determination of one character is completed (S34). Therefore, in each entry determination process repeated in the following S28 to S35, when m=t (0≦t≦n−1), an entry determination is to be made for a character which is located at (t+1)^{th} on calculation from the first character of one phrase.

Further, in S28, a determination is made for whether key entry is made by the character enter key 111 or not, on the basis of an operation signal sent from the keyboard 6. Where it is determined that key entry has been made (S28; Yes), a determination is made for whether keys are correctly entered or not on the basis of types of keys depressed and the determination criterion data stored in the determination criterion data storage area 56E (S29). To be more specific, it is recognized as correct typing when a key corresponding to the character array 22A displayed at the lyrics displaying part 22 of the main game screen 21 (refer to FIGS. 3B and 4B) is depressed. Then, where it is determined that a key other than the corresponding key has been depressed, the number of typing errors is added by one. Thereafter, the typing game machine proceeds to S32.

On the other hand, where it is found that no key entry has been made (S28: No), a determination is made for whether a predetermined time on the basis of the information on a timer 58 (calculation is made after a character array corresponding to one phrase is displayed in relation to the main game screen 21 when the first character of one phrase is entered (S25), whereas calculation is made after a score calculation process when other characters are entered (S33)) has passed or not (S30). Then, where it is determined that a predetermined time has not passed (S30: No), the typing game machine returns to the process in S28.

In contrast, where the CPU 51 determines that a predetermined time has passed (S30: Yes), the number of typing errors in the current game accommodated in the RAM 54 is added by one, on the assumption that no key entry has been made by a player (S31).

Then, in S32, the light emitting process for a key is carried out on the basis of the full color LED 155 provided inside the keyboard 6. To be more specific, in the typing game machine 1 of the embodiment 1, where it is determined that key entry is made (S28: Yes) and a correct typing is also made, the depressed character enter key 111 is emitted in a blue color. Further, where it is determined that key entry is made (S28: Yes) and an erroneous typing is made at the same time, the depressed character enter key 111 is emitted in a red color and a correct key to be entered is emitted in a green color. Further, where no key entry is made (S28: No), a correct key to be entered is emitted in a green color.

Further, in S33, a score calculation process is carried out on the basis of the determination process in the S29 on whether keys are correctly entered or not. In the score calculation process, a score is added where it is determined that the score obtained by a player in the current game and accommodated in the RAM 54 is correctly typed by referring to the above determination process. Also, an additional score is added where it is determined that characters are typed at the same timing with the voice of the musical composition to be performed.

Thereafter, in S34, a variable m accommodated in the RAM 54 is read out to add “+1” and the variable is again accommodated. Then, in S35, a determination is made for whether a value of the variable m has reached n−1 or not, namely, whether all entry determinations for each character that forms one phrase have been completed.

Then, where it is determined that the value of the variable m does not reach n−1 (S35: No), the typing game machine again returns to S28, and an entry determination is made for a character located following position among the characters which form one phrase.

On the other hand where it is determined that the value of the variable m has reached n-1 (S35: Yes), it is deemed that all characters of one phrase have been completely entered. Therefore, in S36, a point adding process is carried out. In the point adding process, where it is determined that n characters constituting one phrase have been completely entered without any typing errors (including determination of typing errors due to passage of a predetermined time (S31)), one point is added.

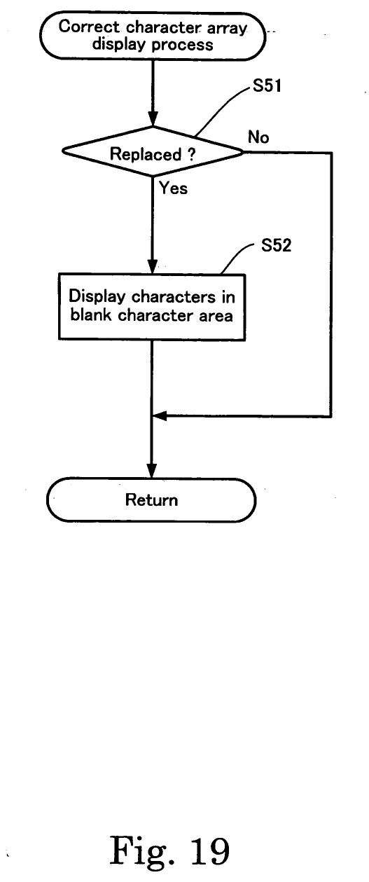

Thereafter, in S37, as shown in FIG. 19, a correct character array displaying process is carried out. In the correct character array displaying process, as described later, where the blank character region 40 is replaced partially by the character array 22A for display, a correct character array which has been regarded as blank characters is displayed in relation to the blank character region 40 (FIG. 7).

Further, in S38, a determination is made for whether or not an entry determination has been completed for a phrase of a stage corresponding to any tune number among a plurality of tune numbers constituting a musical composition (usually one musical composition is composed of one to three tune numbers). Then, where it is determined that an entry determination has not been completed for a whole phrase covering one stage (S38: No), the typing game machine returns to S24. Lyrics of a next phrase are obtained from the RAM 54 and the corresponding character array is displayed at the lyrics displaying part 22 on the main game screen 21.

In contrast, where it is determined that an entry determination has been completed for a whole phrase covering one stage (S38: Yes), a determination is continuously made for whether an entry determination has been completed for phrases covering a whole stage or not (all the tunes in a musical composition) (S39).

Then, where it is determined that a whole stage has been completed (S39: Yes), irrespective of any points owned by a player, the current typing game conduction process is completed, and the typing game machine proceeds to a game result displaying process in S7. On the other hand where it is determined that a whole stage has not been completed (S39: No), a determination is then made for whether the number of typing errors made so far by a player added in the S29 and S31 is less than a predetermined number of typing errors or not (S40). The typing game machine 1 of embodiment 1 is composed of a plurality of stages according to the number of tune numbers of reproduced musical compositions. In order to play a stage related to a next tune number at a time when one stage has been completed, the number of typing errors made so far from the start of a game must be less than a predetermined number of typing errors. (For example, the number of typing errors must be less than 20 times in order to continue to play a part of number 2 after a part of number 1, and the number must be less than 35 times in order to continue to play a part of number 3 after a part of number 2.)

Then, where it is determined that the number of typing errors made so far by a player added in the S29 and S31 is less than a predetermined number of typing errors (S40: Yes), the typing game machine returns to S24. Lyrics corresponding to the first phrase of the next tune number are obtained from the RAM 54, and the corresponding character array is displayed at the lyrics displaying part 22 on the main game screen 21. Then, an entry determination process is carried out similarly. On the other hand, where it is determined that the number of typing errors made by a player is more than a predetermined number of typing errors (S40: No), the typing game conduction process is completed, and the typing game machine proceeds to the game result displaying process in S7.

Next, an explanation will be made by referring to FIG. 18 for a character array displaying process program of the S25 conducted in the typing game machine 1. FIG. 18 is a flow chart of the character array displaying process program for the embodiment 1.

In the character array displaying process, first, when a phrase corresponding to the lyrics data obtained in the S24 is displayed in S41, a replacement display lottery process is carried out for determining by lottery whether the displayed character array 22A is partially replaced by the blank character region 40 or not (the character array 22A is partially non-displayed or not). To be more specific, the replacement lottery table 45 (FIG. 8) is used to hold a lottery according to random number values sampled in the random number sampling circuit 73.

Then, in the subsequent determination process in S42, a determination is made for whether the character array 22A is partially replaced by the blank character region 40 for display or not, on the basis of the lottery result of the replacement display lottery process in the S41. To be more specific, where the sampled random number value is in the range from “0” to “3,” it is determined that the character array is replaced by the blank character region 40 for display (S42: Yes), and the typing game machine proceeds to S43. On the other hand where the sampled random number value is in the range from “4” to “19,” it is determined that a whole sentence of the character array 22A is displayed without replacement by the blank character region 40 (S42: No), and the typing game machine proceeds to S47.

Further, a point acquisition rate (correct answer rate) is calculated in S43. “Points acquired so far by a player” stored in the RAM 54 are divided by “total number of stages played up to the current game” stored in also the RAM 54 to calculate the point acquisition rate.

Then, in S44, the point acquisition rate calculated in the S43 and a blank character number determination table 46 (refer to FIG. 9) are used to determine the number of blank characters (number of characters to be non-displayed). To be more specific, where the acquisition rate of points (correct answer rate) is more than 0.5 (S44: Yes), the number of blank characters is set to be five. The character array 22A corresponding to lyrics data obtained in the S24 and the blank character region 40 composed of five brackets 40A are individually displayed at the lyrics displaying part 22 of the main game screen 21 (refer to S45, FIG. 6B). In this instance, the character array 22A which is non-displayed as the blank characters is a part of the character array defined in advance by the lyrics data (for example, “HA BA TA KE RU” in FIG. 6B).

On the other hand where the point acquisition rate (correct answer rate) is less than 0.5 (S44: No), the number of blank characters is set to be three. The character array 22A corresponding to lyrics data obtained in the S24 and the blank character region 40 composed of three brackets 40A are individually displayed at the lyrics displaying part 22 of the main game screen 21 (refer to S45, FIG. 6B). In this instance, the character array 22A which is non-displayed as the blank characters is a part of the character array defined in advance by the lyrics data (for example, “TA KE RU” in FIG. 6A).

Further, where it is determined by the determination process in the S42 that a whole sentence of the character array 22A is displayed without replacement by the blank character region 40, a whole sentence of the character array 22A corresponding to the lyrics data obtained in the S24 is displayed at the lyrics displaying part 22 in the main game screen 21 (refer to S47, FIG. 4B). Thereafter, the character array displaying process is completed, and the typing game machine proceeds to the process in S26.

Then, the steps S44 and S46 may be altered such that two words are non-displayed in the step S45 and one word is non-displayed in the step S46. To be more specific, where the acquisition rate of points (correct answer rate) is more than 0.5 (S44: Yes), the number of blank characters is set to be two. The character array 22A corresponding to lyrics data obtained in the S24 and the blank character region 40 composed of five and three brackets 40A are individually displayed at the lyrics displaying part 22 of the main game screen 21 (refer to modified S45, FIG. 6C). In this instance, the character array 22A which is non-displayed as the blank characters is a part of the character array defined in advance by the lyrics data (for example, “WINGS” and “SHE” in FIG. 6C).

On the other hand where the point acquisition rate (correct answer rate) is less than 0.5 (S44: No), the number of blank words is set to be one. The character array 22A corresponding to lyrics data obtained in the S24 and the blank character region 40 composed of one word of five brackets 40A are individually displayed at the lyrics displaying part 22 of the main game screen 21 (refer to modified S45, FIG. 6C is modified to non-display “WINGS” (“SHE” is displayed)). In this instance, the character array 22A which is non-displayed as the blank characters is a part of the character array defined in advance by the lyrics data (for example, “WINGS” in modified FIG. 6C).

Then, an explanation will be made by referring to FIG. 19 for a correct character array displaying process program of the S37 which is carried out in the typing game machine 1. FIG. 19 is a flow chart of the correct character array displaying process program for the embodiment 1.

In the correct character array displaying process, first, in S51, a determination is made on the basis of the lottery result of the replacement display lottery process in the S41 for whether the character array 22A of the phrase now being displayed is partially replaced by the blank character region 40 or not. Then, where it is determined that a whole sentence of the character array 22A is displayed without replacement by the blank character region 40 (S51: No), the correct character array displaying process is completed, and the typing game machine proceeds to the determination process in S38.

On the other hand where it is determined that the character array is replaced by the blank character region 40 for display (S51: Yes), a correct character array 41 (for example, “TA KE RU” in FIG. 6A or “HA BA TA KE RU” in FIG. 6B or “wings” and “she” in FIG. 6C) corresponding to lyrics of the musical composition to be performed is newly displayed within the displayed brackets 40A (refer to FIG. 7). Therefore, a player is allowed to recognize a correct character array about a blank part which has been non-displayed.

Thereafter, the correct character array displaying process is completed, and the typing game machine proceeds to the determination process in S38.

As explained so far, in the typing game machine 1 of the embodiment 1, in a state where coins are inserted into the coin insertion slot 9 to start a typing game conduction process (S6), when the character array 22A covering one phrase corresponding to lyrics of a musical composition is to be displayed on the main game screen 21 of the first liquid crystal display 3, a lottery process is carried out for whether the phrase is non-displayed or not by partial replacement by the blank character region 40 (S41). Where it is determined on the basis of the lottery result that the phrase is non-displayed (S42: Yes), the character array is partially replaced by blank character region 40 composed of three or five brackets 40A for display. Therefore, in addition to typing, a new gaming mode, namely anticipation of an non-displayed character array, can be provided to improve the gaming properties. A game does not become monotonous even when the game is played repeatedly and a player does not get bored with the game. Further, since the player is not able to obtain a high score unless he or she memorizes lyrics of a musical composition, even an experienced typist is also able to enjoy the game.

Further, replacement by the blank character region 40 for display would be determined at random according to the lottery result, by which the character array 22A is partially non-displayed at a timing not anticipated by a player, thereby improving the gaming properties. In addition, since the blank character region 40 is displayed at a different timing for each game even when a game is played repeatedly, the player does not get bored with the game.

Since blank characters of the blank character region 40 change in number depending on the point acquisition rate (correct answer rate) (S44 to S46), an increased number of non-displayed characters is given to a player having a higher point acquisition rate (correct answer rate) to raise the degree of difficulty in a game and a decreased number of non-displayed characters is given to a player having a lower point acquisition rate (correct answer rate) to reduce the degree of difficulty in a game. It is, therefore, possible to conduct a game according to the level of a player, thereby improving his or her willingness to play the game.

In the foregoing, Japanese lyrics are picked such that Roman character entry is explained by way of example. However, the lyrics may be in English or other languages. As mentioned above, FIG. 4C shows a case of English lyrics. In this instance, since English is a language space-delimited such that the space key may be included as one character to be typed or it is also possible to make the space key not counted in the typing game (it is the case with this embodiment). FIG. 6C shows blank characters in replacement of the characters to be typed. Here, one blank character corresponds to one character (excluding space key), but one word could be replaced by one blank region or a plurality of words could be replaced by one black region. The situation may be set to adjust the degree of difficulty of the game.

The typing game machine 1 of the embodiment 1 is provided with two liquid crystal displays, namely, the first liquid crystal display 3 and the second liquid crystal display 4. More particularly, a PV screen image 20 of the musical composition to be performed is displayed on the second liquid crystal display 4 disposed above the cabinet (S23) and a main game screen 21 displaying a character array corresponding to lyrics of the musical composition is displayed on the first liquid crystal display 3 disposed below the cabinet 2 in parallel therewith (S22, S24), thus making it possible to provide various typing games using contents displayed on two screens, in comparison with the use of a single liquid crystal display. Therefore, a player does not get bored with a typing game and given an increased willingness to play the game.

Since the PV screen image 20 which is not directly needed in advancing a typing game is not displayed on the main game screen 21, a player can obtain necessary information more easily and play the game in a more concentrated manner.

Further, the PV screen image 20 is displayed on an independent liquid crystal display, thereby making it possible to display an artist singing a song in tune with a musical composition and conduct a typing game in a warmed up ambience than would otherwise be realized conventionally. Therefore, a player does not get bored with the game.

### Embodiment 2

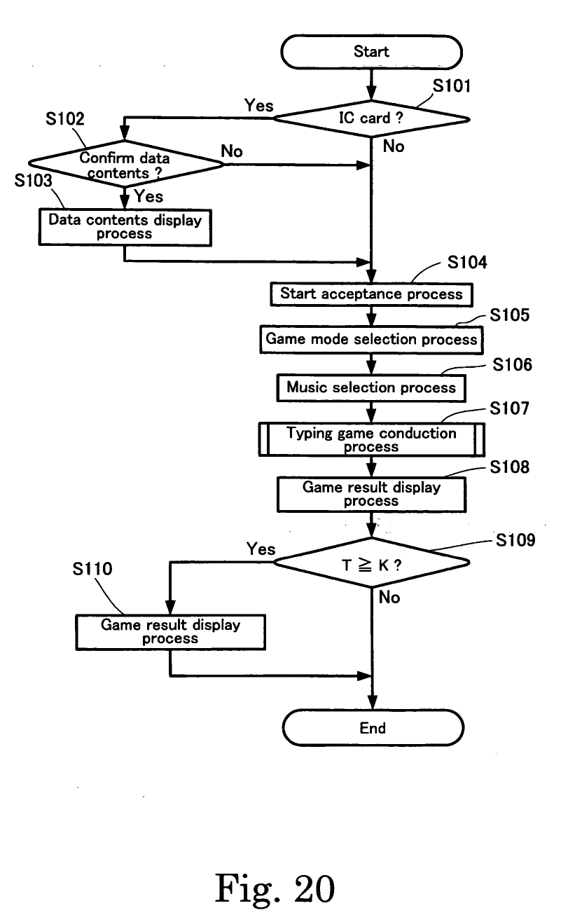

Then, an explanation will be made for the typing game machine of the embodiment 2 by referring to FIGS. 20 to 25. In the following explanation, the same symbols used in constitutions of the typing game machine 1 of the embodiment 1 given in FIG. 1 to FIG. 19 denote parts similar to or corresponding to the constitutions of the typing game machine 1 and others in the embodiment 1.

The typing game machine of the embodiment 2 is approximately similar in constitution to the typing game machine 1 of the embodiment 1. Various control processes are also approximately similar to that of the typing game machine 1 of the embodiment 1.

In the typing game machine 1 of the embodiment 1, a game is controlled on the basis of a single gaming mode in which the character array 22A displayed at the lyrics displaying part 22 is partially replaced by the blank character region 40 at any given timing for display. However, in the typing game machine of the embodiment 2, a player is allowed to select a desired gaming mode from a plurality of gaming modes (three gaming modes, namely, “normal mode,” “hard mode” and “ultra-hard mode”) and in particular where the ultra-hard mode is selected as a gaming mode, as explained later, the main game screen 221 is controlled so that no character array to be typed (namely, lyrics of the musical composition to be performed) is displayed and a player types characters according only to the musical accompaniment to be performed, which is different from the typing game machine 1 of the embodiment 1.

An explanation will be made by referring to FIG. 20, first, for a main process program carried out in the typing game machine of the embodiment 2. FIG. 20 is a flow chart of the main process program for the typing game machine of the embodiment 2. The following programs shown in the flow charts of FIGS. 20 to 22A are stored in the ROM 53 and RAM 54 and executed by the CPU 51 provided in the typing game machine of the embodiment 2.

Regarding the main process, processes in S101 to S104 of the current typing game machine are similar to those in S1 to S4 of the typing game machine 1 of the embodiment 1 (refer to FIG. 15), an overlapping explanation of which is omitted here.

Then, in S105, one gaming mode is selected from a plurality of gaming modes, and a gaming mode selection process is carried out in which a gaming mode of the current game is set. In the typing game machine of the embodiment 2, when coins (100 yen coins and others) are inserted in a predetermined amount (200 yen in the embodiment 2) into the coin insertion slot 9, a gaming mode selection screen 201 is displayed on the first liquid crystal display 3. A player is allowed to select a desired gaming mode from three gaming modes, namely, “normal mode,” “hard mode” and “ultra-hard mode.” Then, in a typing game conduction process (S107) to be described later, a typing game is conducted in a gaming mode selected.

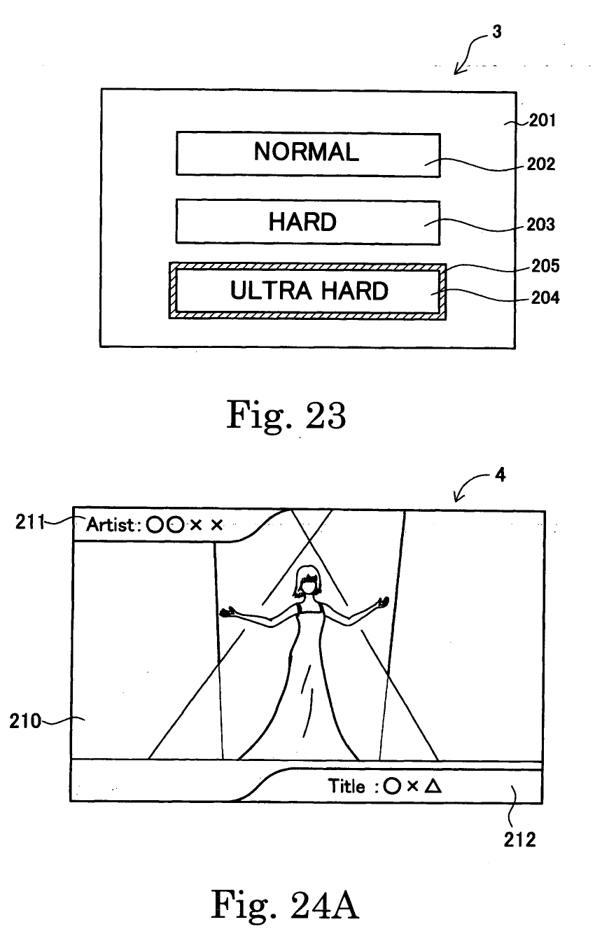

Hereinafter, an explanation will be made by referring to FIG. 23 for a gaming mode selection screen 201 displayed on the first liquid crystal display 3 upon execution of the gaming mode selection process in the S105.

As shown in FIG. 23, the gaming mode selection screen 201 is composed of a normal selecting part 202 displayed as “normal,” a hard selecting part 203 displayed as “hard,” an ultra-hard selecting part 204 displayed as “ultra hard,” and a mode selecting cursor 205 capable of selecting any of the normal selecting part 202, the hard selecting part 203 or the ultra-hard selecting part 204.

The mode selecting cursor 205 is movable vertically at the normal selecting part 202, the hard selecting part 203 and the ultra-hard selecting part 204 by operating the cursor key 114 on the keyboard 6 (refer to FIG. 10). When the enter key 112 (refer to FIG. 10) is depressed, with the mode selecting cursor 205 being located at a selecting part which displays a desired gaming mode, the gaming mode concerned is set as a gaming mode to be played.

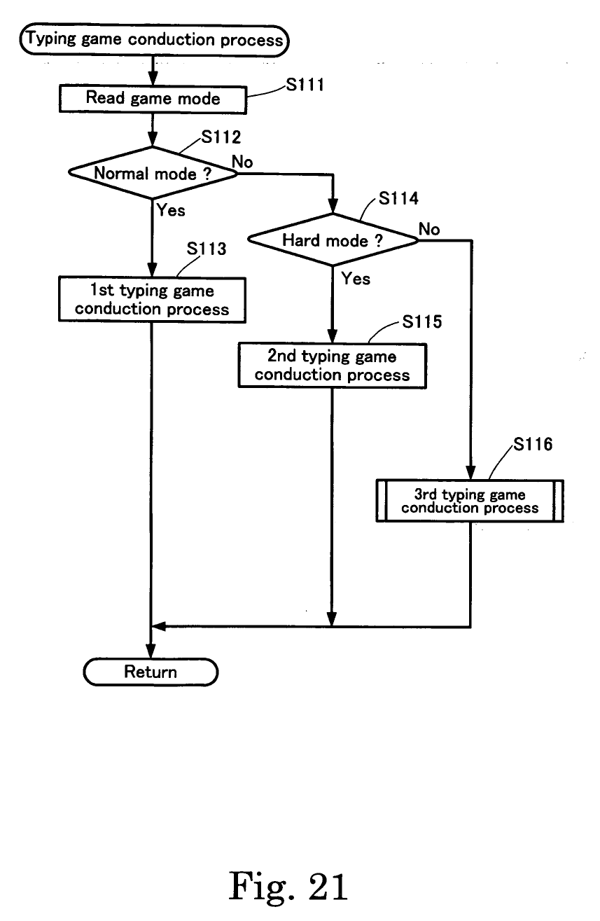

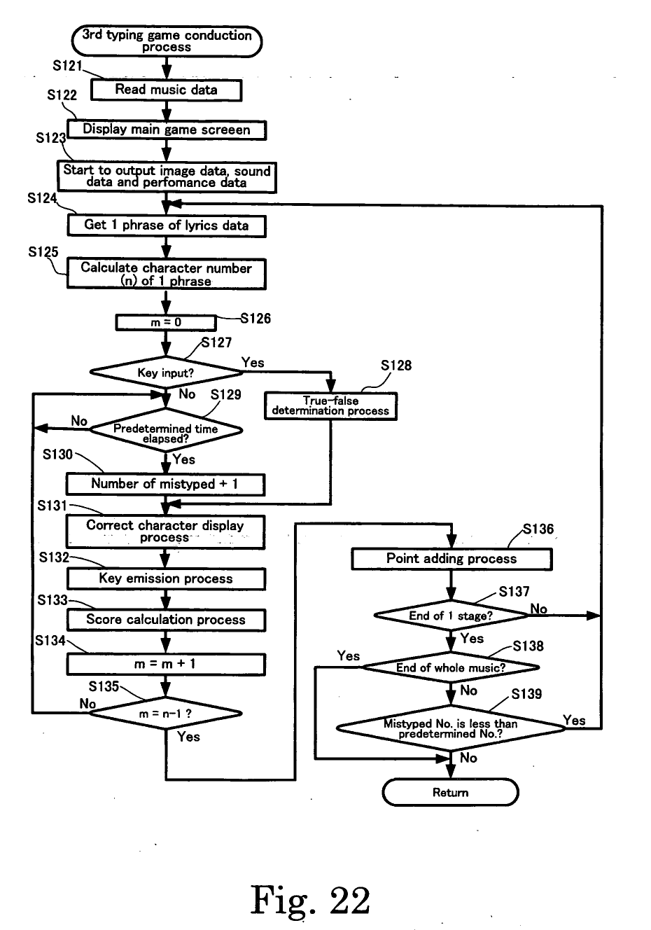

Thereafter, in S106, the musical composition selection process shown FIG. 16 is carried out. Further, in S107, the typing game conduction process shown in FIGS. 21 and 22 is carried out on the basis of the gaming mode set in the S105 and the musical composition set in the S106. As explained later, in the typing game conduction process, a game is conducted until predetermined requirements are met by each mode of the games corresponding to the thus set gaming modes, a musical composition is performed, and scores and points, etc., are added on the basis of the type result of the keyboard 6.

Further, regarding the main process, processes in S108 to S110 of the current typing game machine are similar to those in S7 to S9 of the typing game machine 1 of the embodiment 1 (refer to FIG. 15), an overlapping explanation of which is omitted here.

Then, an explanation will be made by referring to FIG. 21 for a typing game conduction process program of the S107 carried out in the typing game machine of the embodiment 2. FIG. 21 is a flow chart of the typing game conduction process program for the embodiment 2.

In the typing game conduction process, first, in S111, a gaming mode set in the S105 is read out. Then, in S112, a determination is made for whether the gaming mode read out in the S111 is “normal mode” or not.

Then, where it is determined that the read-out gaming mode is “normal mode” (S112: Yes), a first typing game conduction process is carried out, which is a game based on the normal mode (S113). In this instance, as shown in FIGS. 3B and 4B, the first typing game conduction process allows the lyrics displaying part 22 to constantly display a whole sentence of the character array to be typed (namely, lyrics of the musical composition to be performed). Then, a determination is made for whether the key is correctly entered or not on the basis of an operation signal from the keyboard 6 and determination criterion data stored in the determination criterion data storage area 56E. A typing game process in which scores and the number of typing errors are added is carried out according to the determination result. A detailed explanation will be omitted about the first typing game conduction process which is carried out in the typing game machine of the embodiment 2.

On the other hand where it is determined that the read-out gaming mode is not the “normal mode” (S112: No), a determination is continuously made for whether the gaming mode read out in the S111 is the “hard mode” or not (S114).

Then, where it is determined that the read-out gaming mode is the “hard mode” (S114: Yes), a second typing game conduction process which is a game based on the hard mode is carried out (S115). In this instance, as shown in FIGS. 6A-6C, the second typing game conduction process makes non-displayed a part of the character array to be typed (namely, lyrics of the musical composition to be performed) which is displayed at random at the lyrics displaying part 22. Then, a determination is made for whether the key is correctly entered or not on the basis of an operation signal from the keyboard 6 and determination criterion data stored in the determination criterion data storage area 56E. A typing game process in which scores and the number of typing errors are added is carried out according to the determination result. The second typing game conduction process carried out in the typing game machine of the embodiment 2 is similar to the typing game conduction process of the embodiment 1 (FIG. 17) and, therefore, a detailed explanation will be omitted.

Further, where it is determined that the read-out gaming mode is not the “hard mode” (S114: No) but the “ultra-hard mode,” a third typing game conduction process which is a game based on the ultra-hard mode is carried out (S116). In this instance, the third typing game conduction process does not display at all the character array to be typed (namely, lyrics of the musical composition to be performed) on the main game screen 221 or output the voice on the basis of the audio data stored in the audio data storage area 56C, but only outputs the musical accompaniment on the basis of performance data stored in the performance data storage area 56B. Then, a determination is made for whether the key is correctly entered or not on the basis of an operation signal from the keyboard 6 and determination criterion data stored in the determination criterion data storage area 56E. A typing game process in which scores and the number of typing errors are added is carried out according to the determination result.

Hereinafter, an explanation will be made by referring to FIG. 22 for the third typing game conduction process program of the S116 carried out in the typing game machine of the embodiment 2. FIG. 22 is a flow chart of the third typing game conduction process program of the embodiment 2.

In the third typing game conduction process, in S121, first, the CPU 51 reads out music data corresponding to the musical composition selected by the musical composition selection process in the S106, among music data stored in each storage area (refer to FIG. 14) of the music data storage area 56 of the HDD. Then, in particular, lyrics data accommodated in the lyrics data storage area 56D are divided into each phrase and temporarily stored in the RAM 54.

In S122, the main game screen 221 which keeps non-displayed the character array to be typed is displayed on the first liquid crystal display 3. Then, in S123, the PV screen image 210 of the musical composition selected by the second liquid crystal display 4 is started for display on the basis of the screen image data stored in the screen image data storage area 56A. Further, musical accompaniment is output via the speakers 8 on the basis of the performance data stored in the performance data storage area 56B, thereby making it possible to perform the musical accompaniment alone from which voice of the musical composition is removed and also reproduce the PV screen image 210 accordingly.

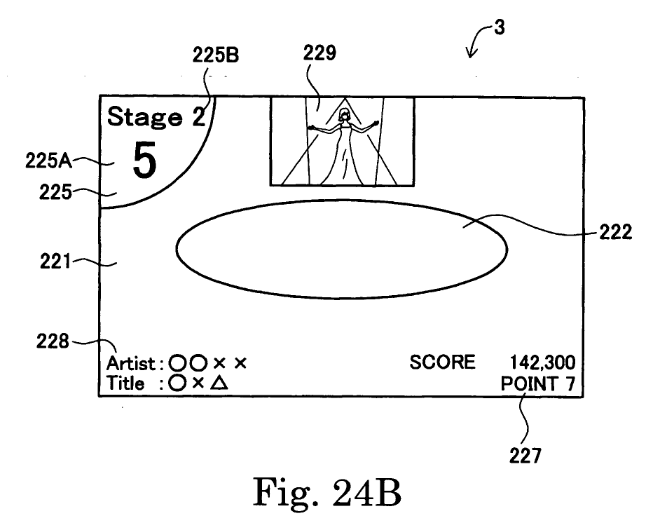

Hereinafter, an explanation will be made by referring to FIG. 24 for the contents displayed on the first liquid crystal display 3 and the second liquid crystal display 4 while the third typing game of the S122A and thereafter is in progress. FIGS. 24A and 24B respectively show the contents displayed on the first liquid crystal display 3 and the second liquid crystal display 4 in a case where a predetermined musical composition performed by a female artist is selected to start a typing game.

As shown in FIG. 24A, a PV screen image 210 of a female artist who sings a song in tune with the musical accompaniment of the musical composition performed via speakers 8 is displayed on the second liquid crystal display 4. However, the voice of the singing female artist is not output from the speakers 8.

Further, as shown in FIG. 24A, an artist name information displaying part 211 for displaying the name of an artist now performing is provided at the upper left end of the second liquid crystal display 4 displaying the PV screen image 210, and a music title information displaying part 212 for displaying the music title now being performed is provided at the right lower end of the second liquid crystal display 4 displaying the PV screen image 210.

In addition, as shown in FIG. 24B, a main game screen 221 on the progress of a typing game is displayed on the first liquid crystal display 3, together with display of the PV screen image 210 on the second liquid crystal display 4.

The main game screen 221 is composed of an entered lyrics displaying part 222 which displays a part of lyrics which has been already entered by a player among lyrics of a phrase now being performed in Chinese characters, Japanese syllabary or others, a musical composition status displaying part 225 which displays what tune number (stage number) the phrase of the musical composition now being performed is equivalent to and also what number of the phrase it is also equivalent to on calculation from the time when the tune number concerned is started, a score displaying part 227 which displays scores, points and others so far acquired by a player, a music information displaying part 228 which displays the name of an artist and the music title now being performed PV screen image displayed on the second liquid crystal display 4.

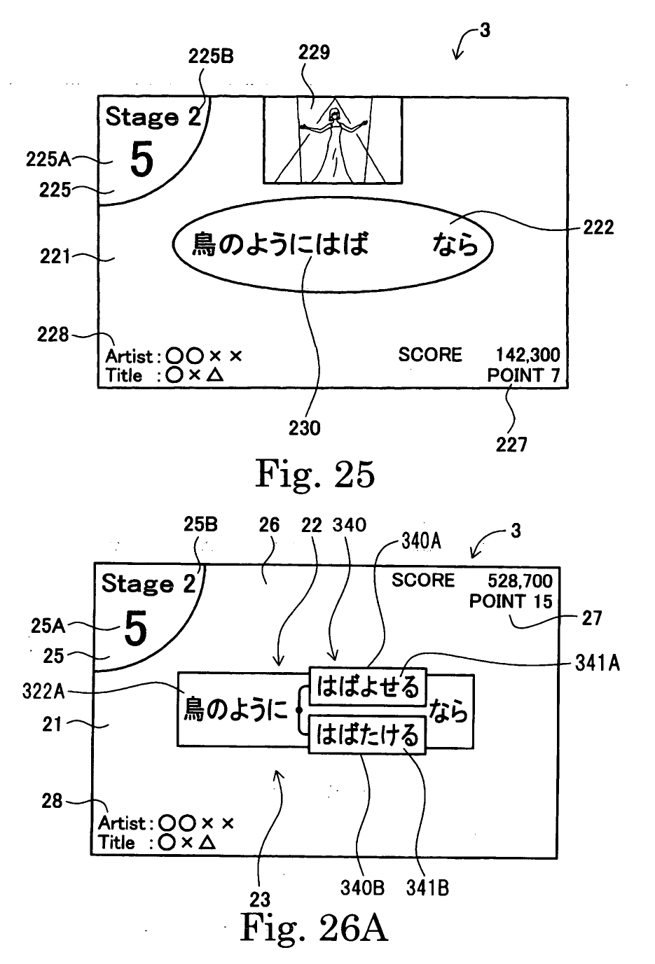

In this instance, the entered lyrics displaying part 222 is free of display of a character array, as shown in FIG. 24B, when a player does not type a part of the phrase now being performed. However, when a part of lyrics is typed on the basis of correct lyrics at an appropriate timing of lyrics covering one phrase of the musical composition now being performed, the corresponding character array 230 is displayed at the entered lyrics displaying part 222 after being typed (refer to S131, FIG. 25).

Next, lyrics covering one phrase of lyrics data accommodated in the RAM 54 are obtained in S123. Thereafter, in S125, the number of characters for one phrase, n, is calculated on the basis of the one-phrase lyrics data obtained in the S124 and zero is assigned to any given variable m accommodated in the RAM 54 (S126). In this instance, any given variable m is a variable used in judging a character entered corresponding to each character constituting one phrase and one variable is added each time when entry determination of one character is completed (S133). Therefore, in each entry determination process repeated in the following S127 to S134, when m=t (0≦t≦n−1), an entry determination is to be made for a character which is located at (t+1)^{th} if counted from the first character of one phrase.

Further, in S127, a determination is made for whether key entry is made by the character enter key 111 or not according to an operation signal sent from the keyboard 6. Where it is determined that key entry has been made (S127; Yes), a determination is made for whether keys are correctly entered or not on the basis of types of keys depressed and the determination criterion data stored in the determination criterion data storage area 56E (S128). To be more specific, it is determined that a correct typing has been made when a key corresponding to the lyrics of the musical composition to be performed is depressed. Then, where it is determined that a key other than the corresponding key has been depressed, the number of typing errors is added by one. Thereafter, the typing game machine proceeds to S131.

On the other hand where it is determined that no key entry has been made (S127: No), a determination is made by referring to the information on a timer 58 for whether an entry timing has passed or not for the character located at (m+1)^{th} if counted from the first character of one phrase (S129). In this instance, the entry timing is a certain period predetermined for each character constituting the phrase (for example, 127.5 to 128.8 seconds from start of performance) and the period is stored in the determination criterion data storage area 56E. Then, where it is determined that the entry timing has not passed (S129: No), the typing game machine returns to the process in S127.

In contrast, where the CPU 51 determines that the entry timing has passed (S129: Yes), the number of typing errors in the current game accommodated in the RAM 54 is added by one, on the assumption that no key entry has been made by a player (S130).

Thereafter, a correct character displaying process is carried out in S131. In the correct character displaying process, a character located at (m+1)^{th} on calculation from the first character of one phrase is displayed only where it is determined that a correct key is typed within an appropriate entry timing at the entered lyrics displaying part 222 of the main game screen 221.

For example, FIG. 25 shows a case where among the phrase covering “TO RI NO YO U NI HA BA TA KE RU NA RA,” characters covering a part of the lyrics “TA KE RU” are not entered in an appropriate manner. In this case, only parts of the lyrics covering “TO RI NO YO U NI HA BA” and “NA RA” are displayed by the character array 230, by which a player can be notified of the part of lyrics appropriately typed by the player.

When the above applies to FIG. 6C, if “she” of the phrase of “heartaches had wings she would fly” could not be typed, only “heartaches had wings” and “would fly” could be displayed in the character array 230. Therefore, the player can be notified of the part correctly typed.

Then, in S132, a key is subjected to light emitting process according to the full color LED 155 installed inside the keyboard 6. To be more specific, in the typing game machine 1 of the embodiment 1, where it is determined that key entry is made within the entry timing (S127: Yes) and also a correct typing is made, the depressed character enter key 111 is emitted in a blue color. Further, where it is determined that key entry is made within the entry timing (S127: Yes) and also an erroneous typing is made, the depressed character enter key 111 is emitted in a red color and a correct key to be entered is emitted in a green color. Further, where no key entry is made (S127: No), a correct key to be entered is emitted in a green color.

Further, in S133, a score calculation process is carried out according to the determination process in the S128 on whether keys are correctly entered or not. In the score calculation process, a score is added where it is determined by referring to the determination process that the score obtained by a player in the current game accommodated in the RAM 54 is correctly typed. Also, additional score is added where it is determined that the corresponding characters are typed at the same timing with the voice of musical accompaniment of the musical composition to be performed.

Thereafter, in S134, a variable m accommodated in the RAM 54 is read out to add “+1” and the variable is again accommodated. Then, in S135, a determination is made for whether a value of the variable m has reached n−1 or not, namely, all characters corresponding to individual characters which constitute one phrase have been completely entered.

Then, where it is determined that the value of the variable m does not reach n−1 (S135: No), the typing game machine again returns to S127, and a determination is made for whether a character located next to each of the characters which form one phrase has been entered or not.

On the other hand where it is determined that the value of the variable m has reached n−1 (S135: Yes), it is deemed that characters of one phrase have been completely entered. Therefore, in S136, a point adding process is carried out. In the point adding process, where it is determined that n characters constituting one phrase have been completely entered without any typing errors (including determination of typing errors due to passage of a predetermined time (S130)), one point is added.

Further, in S137, a determination is made for whether or not an entry determination has been completed for a phrase of a stage corresponding to any tune number among a plurality of tune numbers constituting a musical composition (usually, one musical composition is composed of one to three tune numbers). Then, where it is determined that an entry determination has not been completed for a whole phrase covering one stage (S137: No), the typing game machine returns to S124. Lyrics of a next phrase are obtained from the RAM 54.

In contrast, where it is determined that an entry determination has been completed for a whole phrase covering one stage (S137: Yes), a determination is continuously made for whether or not an entry determination has been completed for phrases covering a whole stage (all tunes in a musical composition) (S138).

Then, where it is determined that a whole stage has been completed (S138: Yes), irrespective of any points owned by a player, the current typing game conduction process is completed, and the typing game machine proceeds to a game result displaying process in S108. On the other hand where it is determined that a whole stage has not been completed (S138: No), a determination is then made for whether the number of typing errors made so far by a player added in the S128 and S130 is less than a predetermined number of typing errors or not (S139).

Then, where it is determined that the number of typing errors made so far by a player added in the S128 and S130 is less than a predetermined number of typing errors (S139: Yes), the typing game machine returns to S124. Lyrics corresponding to the first phrase of the next tune number are obtained from the RAM 54, and an entry determination process is similarly carried out. On the other hand where it is determined that the number of typing errors made by a player is more than a predetermined number of typing errors (S139: No), the typing game conduction process is completed, and the typing game machine proceeds to the game result displaying process in S108.

As so far explained, in the typing game machine 1 of the embodiment 2, after coins are inserted into the coin insertion slot 9, a gaming mode selection screen 201 for selecting a gaming mode is displayed on the first liquid crystal display 3. When the ultra-hard mode is set as a gaming mode, in particular, lyrics of the musical composition to be performed or the character array to be typed on the main game screen 221 are non-displayed, and only the musical accompaniment of a musical composition is output from the speakers 8. Therefore, a player does not visually recognize characters to be typed according to the displayed character array but recognizes by an auditory perception the characters to be typed and the entry timing according to the music performed. The current typing machine is able to provide a new game in which a player selects a gaming mode by his or her own will.

Further, since a player is unable to obtain a high score unless he or she memorizes lyrics of a musical composition and learns the timing when a song is sung, the player is motivated to play a game again and even an experienced typist is also able to sufficiently enjoy the game.

The present invention is not restricted to the above embodiments but a variety of modifications may be made without departing from the spirit and scope of the invention.

For example, in the typing game machine of the embodiment 1, a determination is made for whether a player is familiar with a game or not by referring to the level of point acquisition rate (correct answer rate) (S44), thereby changing the number of characters non-displayed. The number of characters non-displayed may be determined by referring to a percentage of typing errors in relation to a total number of stages played by a player.

Further, in the embodiment 1, the number of blank characters is set to be either three or five characters, thereby displaying the blank character region 40. There is no restriction in the number of blank characters of three or five characters, and a whole displayed character array may be used as blank characters, thereby making it possible to provide a new gaming mode in which a player enters lyrics only on the basis of the musical composition to be performed. In addition, in place of making the character array 22A partially non-displayed, the character array 22A may be displayed by selecting a correct character array from a plurality of character arrays.

In addition, in the embodiment 2, where a game is played in accordance with the “ultra-hard mode” as a gaming mode, a PV screen image is displayed on the first liquid crystal display 3 and the second liquid crystal display 4. However, no PV screen image may be displayed on any of the respective displays, by which a player is unable to anticipate lyrics on the basis of the PV screen image and a game is more suitable for an experienced player.

In the embodiment 2, where a game is played on the basis of the “ultra-hard mode” as a gaming mode, only musical accompaniment of the selected musical composition is output. However, only a voice sung by an artist may be output or, both of the musical accompaniment and the voice may be output.

Further, in the embodiment 2, where a game is played on the basis of the “ultra-hard mode,” as a gaming mode, in place of a musical composition status displaying part 225, passage time from the start of performing music may be displayed. It is, therefore, possible to provide a new game in which characters are typed in anticipation of lyrics on the basis of elapsed time from the start of performing music.

In addition, the typing game machine 1 of the embodiment 1 or the embodiment 2 is connected to a server 80 via a network N which can bi-directionally communicate such as the Internet, and music data stored in the HDD 55 of the typing game machine 1 (refer to FIG. 13) can be updated on the basis of the data sent from the server 80. However, the music data may be updated independently of the server 80.

As described above, an explanation has been made for the cabinet-type typing game machine 1 placed at game arcades as an example of the typing game machine of the present invention. The invention is also applicable to a typing game machine in which software is installed in a personal computer. It is also applicable to a typing game for a home gaming unit, which is provided as media such as a cartridge and CD-ROM. A typing game may be built in a home gaming unit.

The following will explain another embodiment.

In the following explanation, the same numeral references of the typing game machine of the embodiment 1 as shown in FIGS. 1 to 19 shows indicate the same or the equivalent part or portion of the typing game machine 1 of the embodiment 1.

The configuration of the typing game of this embodiment is almost the same as with the typing game 1 of the embodiment 1. And each control process is also almost the same as with the typing game machine 1.

However, in the typing game machine 1 of the embodiment 1, the game is controlled such that the character array is partially replaced by a blank character region 40 at any timing. In this typing game machine according to this other embodiment, the character array 22A displayed in lyrics display region 22 is partially replaced by the selective group 340 at any timing, thereby making this typing game machine distinguishable from the typing game machine 1 of the embodiment 1 as mentioned above.

The lyrics displaying part 22 is a displaying part which displays the character array 22A corresponding to one phrase of the lyrics of the musical composition now being performed and the game proceeds as the player operates the keyboard 6 to type the character array 22A displayed in the lyrics displaying part 22. Then, scores are gradually added when the player correctly types the phrases of the lyrics displayed, whereas scores are not added when he or she erroneously types characters irrespective of the lyrics and the number of typing errors is also added as the number of erroneous entries. When the number of typing errors exceeds a predetermined number after completion of any tune number, among the tune numbers (stages) constituting the musical composition, the game is instantly terminated (refer to S40 in FIG. 30).

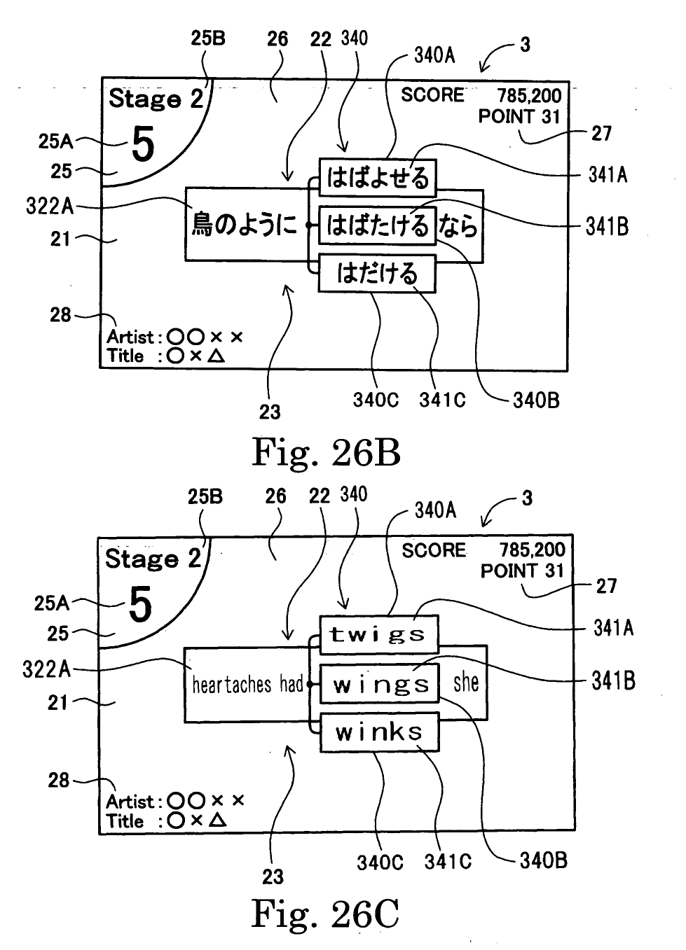

The character array 22A displayed in the lyrics displaying part 22 is partially displayed at any given timing in a state of being replaced by a group of selective character arrays 340 (refer to FIGS. 26A-26B). In this instance, the group of selective character arrays 340 is a special character array that shows two or more similar selective character arrays including the correct character array and that urges the player to type the correct characters of the lyrics with the help of his or her memory and/or guess. The group of selective character arrays 340 will be explained later in detail.

The Roman character display part 23 is a region for newly displaying the character array 23A already typed by the player in Roman characters among character arrays 22 corresponding to the lyrics displayed in the lyrics displaying part 22. It is, therefore, possible to notify a player of characters so far typed.

Further, the musical composition status displaying part 25 is to display what tune number the phrase of the lyrics currently being displayed in the lyrics displaying part 22 belongs to and what number of the tune the phrase is in if counted from the beginning of the tune being performed. In this instance, the typing game of this embodiment is composed of a plurality of stages (for example, first to third stages) in accordance with the number of tune numbers of the musical compositions to be reproduced (for example, one musical composition is composed of tune numbers 1 to 3). For example, FIG. 3B now shows the 15th phrase of the first stage (tune number 1). Further, FIG. 4B now shows the 5th phrase of the stage 2 (tune number 2).

Then, a value 25A showing the phrase number is added one by one every time when entry of one phrase by a player is completed, and a value 25B showing the stage number (tune number) is added one by one every time when entry of one stage is completed. It is, therefore, possible to notify the player of the currently available stage number (tune number) and the phrase number so far completely typed.

The type result displaying part 26 is a part for displaying the determination result of correct or incorrect typing of the player, and when a corresponding correct character is typed at the same timing with the sound of the performed musical composition, “PERFECT” is displayed. Further, when a correct character is typed not at the same timing as the corresponding sound of the musical composition is performed, “GOOD” is displayed. On the other hand when a wrong character is typed irrespective of the timing of the sound, “MISS” is displayed.

The score displaying part 27 is a part for displaying the scores and points so far acquired by the player. In this instance, the score is added when characters are correctly typed according to the character array 22A displayed at the lyrics displaying part 22. Further, when the corresponding character is typed at the same timing as the corresponding sound of the musical composition is performed, an additional score is acquired. On the other hand one point is added every time when one phrase is typed completely without any typing errors (S36 in FIG. 30).

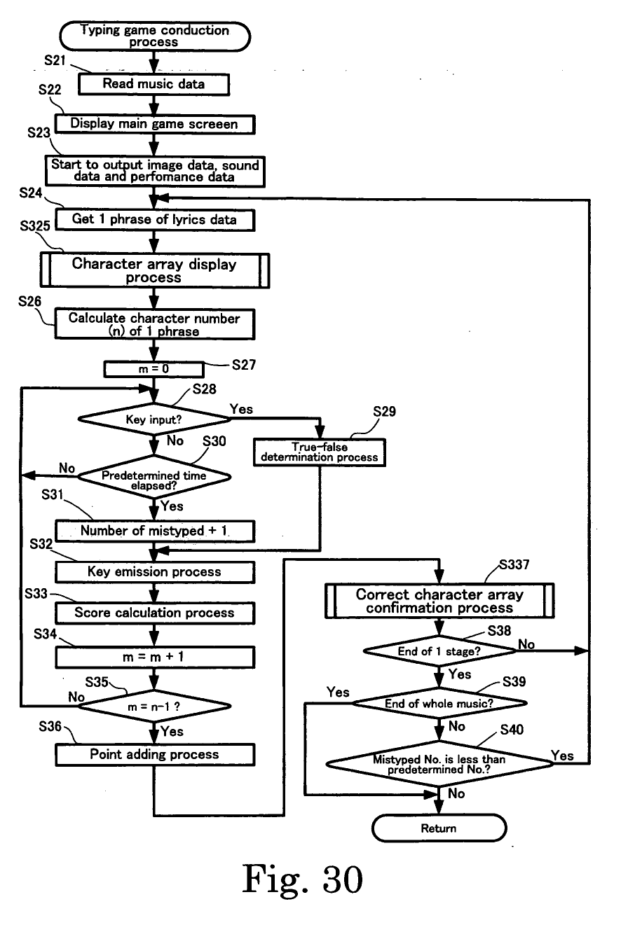

Then, the number of blank characters (the number of non-displayed characters) at the blank character region 40 displayed by the lyrics displaying part 22 is varied, as described later, depending on whether or not the number of points so far acquired reaches a predetermined percentage in relation to the phrase number so far completely typed (refer to FIG. 29). To be more specific, an increased number of selective character arrays is given to the player having a higher point acquisition rate (correct answer rate) to raise the degree of difficulty in the game, and a decreased number of selective character arrays is given to the player having a lower point acquisition rate (correct answer rate) to reduce the degree of difficulty in the game. It is, therefore, possible to conduct the game according to the level of the player, thereby enhancing his or her desire to play the game.

Further, the scores and points are added until completion of the game, and where an IC card is inserted into the card insertion slot 10 of the center panel 5, the scores and points acquired upon completion of the game are stored in the IC card (S9 in FIG. 15).

In addition, the music information displaying part 28 displays the title of a musical composition and the name of an artist which is selected by a player at the time of starting the game and now being performed.

In this embodiment, the main game screen 21 is to be displayed on the first liquid crystal display 3, and the PV screen image 20 is to be displayed on the second liquid crystal display 4. However, in contrast, the PV screen image 20 may be displayed on the first liquid crystal display 3 and the main game screen 21 may be displayed on the second liquid crystal display 4.

Then, as shown in FIG. 5, after completion of the typing game, a game result screen 30 showing the result of the current typing game is displayed on the first liquid crystal display 3.

The game result screen 30 is composed of a typing-error number displaying part 31 which displays the number of typing errors made in the current typing game, an acquisition point displaying part 32 which displays acquired points, an acquisition score displaying part 33 which displays acquired scores and a name entry displaying part 34 which prompts the game player to enter his or her name.

Then, by referring to the game result screen 30, the player knows the number of typing errors made in the current typing game and the acquired points and scores. Further, the player uses the keyboard 6 to enter any given name into the name entry displaying part 34, thereby making it possible to register the acquired scores in the ranking. A list of the thus registered ranking is displayed on the first liquid crystal display 3 or the second liquid crystal display 4 as a demonstration screen or the like.

Further, while the game result screen 30 is displayed on the first liquid crystal display 3, the PV of any given musical composition may be provided on the second liquid crystal display 4. Images for advertisement and the like may also be displayed. In addition, the game result screen 30 may be displayed not on the first liquid crystal display 3 but on the second liquid crystal display 4.

Next, an explanation will be made in referring to FIGS. 26A to 29 for the group of selective character arrays 340 which is displayed at any given time in the lyrics displaying part 22. First, an explanation will be made in referring to FIGS. 26A-6C and 27A and 27B for a displaying mode of the group of selective character arrays displayed on the first liquid crystal display 3 while the typing game is in progress. FIG. 26A shows general contents displayed on the first liquid crystal display 3 upon display of the group of selective character arrays 340 where the number of selective arrays is set to be 2. FIGS. 26B and 26C show the general contents displayed on the first liquid crystal display 3 upon display of the group of selective character arrays 340 where the number of selective character arrays is set to be 3. FIG. 26C shows the general contents if the lyrics are in English. FIG. 7 shows general contents displayed on the first liquid crystal display 3 at the completion of typing one phrase when the blank character region 40 is shown.

As shown in FIGS. 26A-26C, the character array 22A displayed in the lyrics displaying part 22 is partially replaced by the group of selective character arrays 340 at any given timing for display. In the group of selective character arrays 340, two or three selective character arrays 341A-341B are arranged and displayed in parallel, and the player may select one character array which may correspond to the correct phrased of the lyrics by guessing the correct character array and enter characters according to the selected character array. Further, a musical composition to be performed is controlled so that the sound of the phrase of the lyrics corresponding to the correct one from the group of the selective character arrays 340 is outputted only when characters of the correct phrase of the lyrics (for example, character array 341B shown in FIGS. 26A-26C) are entered. Unless the player memorizes or guesses correctly the lyrics of the musical composition to be performed, he or she cannot type the correct character array and let the speaker reproduce the sound of the corresponding phrase of the lyrics, thereby making it possible to enhance his or her desire to play the game.

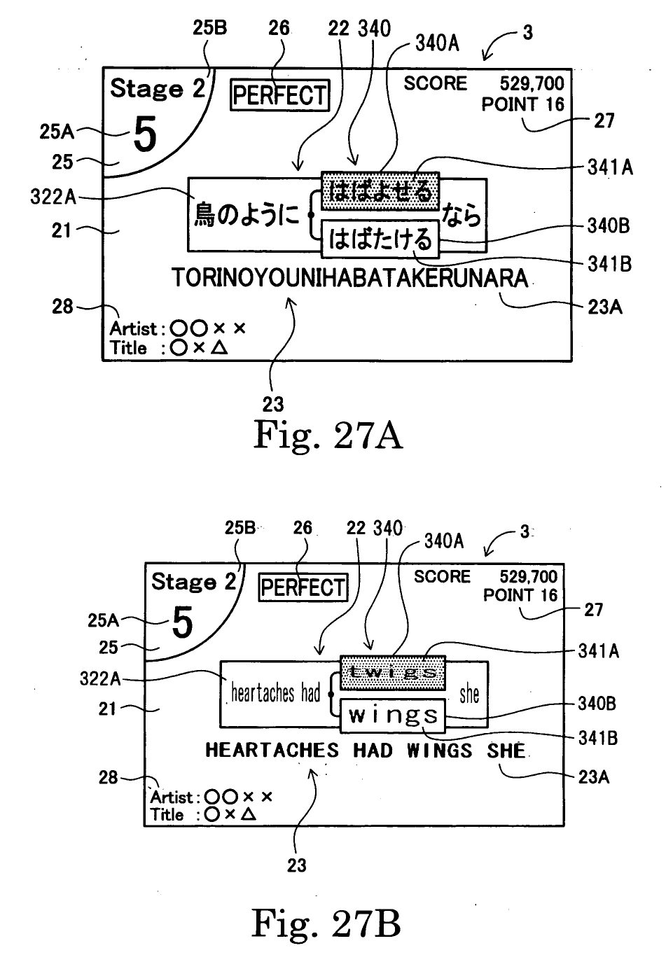

First, in this instance, as shown in FIG. 26A, an explanation will be made for the group of the selective character arrays 340 being composed of two candidates. The group of the selective character arrays 340 is constituted by the first candidate display part 340A and the second candidate display part 340B, which are arranged in two rows (top and bottom rows). Thus, the first selective character array 341A is shown in the first candidate display part 340A and the second selective character array 341B is shown in the second candidate display part 340B. Either the first selective character array 341A or the second selective character array 341B is constituted by the correct character array (for example, “HA BA TA KE RU” in FIG. 26A and “wings” in FIG. 27B) of the music to be performed. The other selective character array is constituted by a character array which is similar to but different form the correct one (for example, “HA BA YO SE RU” in FIG. 26A and “twigs” in FIG. 27B).

Then, when the player types characters for entry on the basis of the displayed main game screen 21, a determination is made for whether the characters are typed correctly or not in a similar manner of an ordinary typing game, and the entered character array 23A is displayed in the Roman character display part 23. At the time when all the displayed character array corresponding to one phrase of the lyrics has been completely entered, as shown in FIG. 27A, the display mode is changed such that the second candidate display part 340B showing the correct character array is kept displayed and that the first candidate display part 340A having the wrong character array is made non-displayed (or hidden) by shading (e.g., “twigs” is non-displayed in FIG. 27B). Here, it is determined that the correct character array is displayed either in the first candidate display part 340A or the second candidate display part 340B by the internal lottery which utilizes a random number sampled by the random number sampling circuit 73 (refer to FIG. 13). Thus, the arrangement is changed for each game.

Next, as shown in FIGS. 26B and 26C, an explanation will be made for the group of selective character arrays 340 being composed of three candidates. The group of selective character arrays 340 is configured with the first candidate display part 340A, the second candidate display part 340B, and the third candidate display part 340C, which are arranged in three parallel rows. And the first selective character array 341A is displayed in the first candidate display part 340A, the second selective character array 341B is displayed in the second candidate display part 340B, and the third selective character array 341C is displayed in the third candidate display part 340A. Here, one of the first to third selective character arrays 341A-341C is composed of a character array corresponding to the correct phrase of the lyrics of the music being performed (for example, “HA BA TA KE RU” in FIG. 26B and “wing” in FIG. 26C). On the other hand, the other character arrays to be displayed are composed of similar but wrong character arrays (for example, “HA BA YO SE RU” and “HA DA KE RU” in FIG. 26B, and “twigs” and “winks” in FIG. 26C).

Then, when the player types characters, a determination is made for whether the characters are typed correctly or not in a similar manner of the ordinary typing game, and the character array 23A entered is displayed at the Roman character display part 23. At the time when all the displayed character array corresponding to one phrase of the lyrics has been completely entered, although not illustrated, the second candidate display part 340B showing the correct character array is kept displayed and the first and the third candidate display parts 340A and 340C having wrong character arrays, respectively, are non-displayed (or hidden) in the same way as the group of selective character arrays 340 being composed two candidates. Here, it is determined in which one the of the first to third candidate display parts 340A-340C the correct character array is displayed by the internal lottery which utilizes a random number sampled by the random number sampling circuit 73 (refer to FIG. 13). Thus, the arrangement is changed for each game.

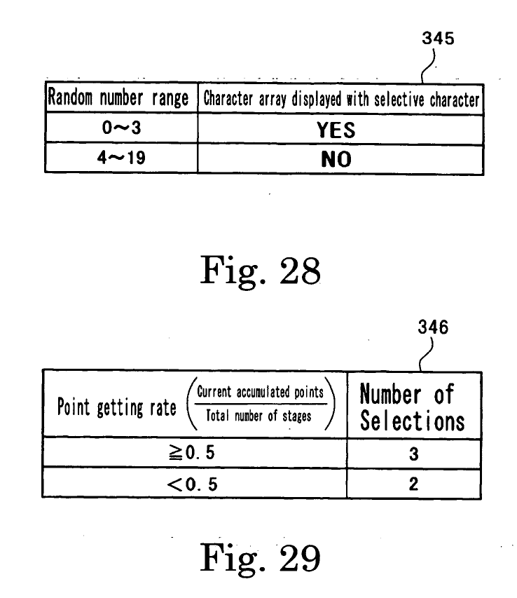

Further, an explanation will be made in referring to FIG. 28 for a replacement lottery table 345 which is used when it is determined whether or not the character array 22A is partially replaced by the group of selective character arrays 340. FIG. 28 is a drawing showing the replacement lottery table 345 related to this embodiment.

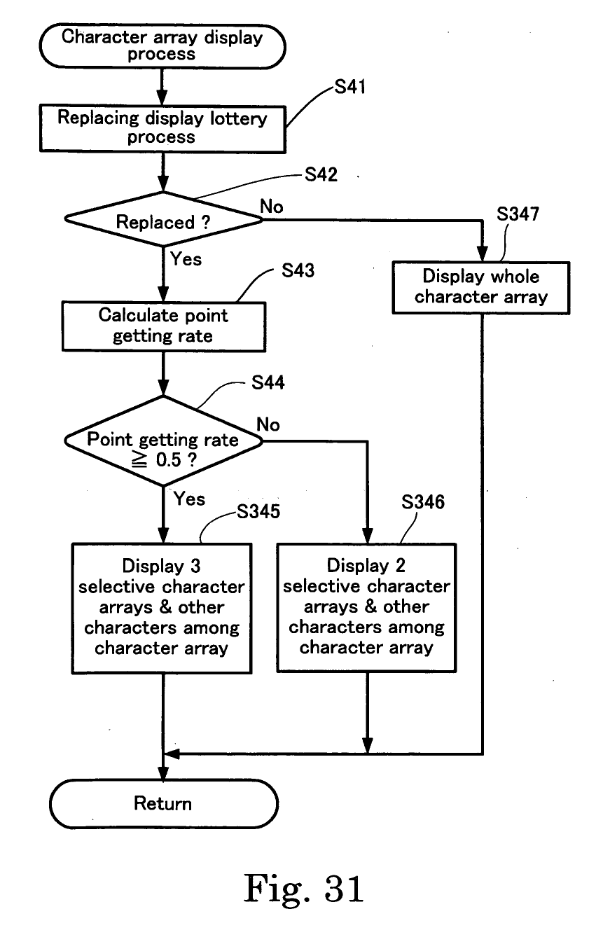

The replacement lottery table 345 is a lottery table for drawing lots on the basis of a random number value sampled by the random number sampling circuit 73 for displaying the displayed character array 22A during the typing game being conducted is partially replaced by the group of selective character arrays 340. To be more specific, a lottery is made by using the replacement lottery table 345 every time when a new phrase is displayed (refer to S41 in FIG. 31). As shown in FIG. 28, where the random number value is in the range from 0 to 3, the character array 22A of the thus displayed phrase is partially replaced by the group of selective character arrays 340 for display (refer to FIGS. 26A-26C). Meanwhile, where the random number value is in the range from 4 to 19, the whole character array 22A corresponding to the phrase of the lyrics is displayed as usual, without displaying the group of selective character arrays 340 (refer to FIGS. 3B and 4B-4C). The replacement lottery table 345 is stored in a ROM 53 (refer to FIG. 13).

Further, with reference to FIG. 29, an explanation will be made for a candidate number determination table 346 used in determining the number of the candidate character arrays. FIG. 29 is a drawing to show the candidate number determination table 346 of this embodiment.

The candidate number determination table 346 is a table for determining the number of the candidate character arrays of the group of selective character arrays 340 on the basis of a point acquisition rate (correct answer rate) when the displayed character array 22A during the typing game being conducted is partially replaced by the group of selective character arrays 340 for display. In this instance, the point acquisition rate is a value obtained by dividing “current point number obtained by the player” by “total stage number played so far in the present game.” As described previously, one point is added every time when one phrase is completely entered without any typing errors, and the point acquisition rate is a value showing a correct answer rate of the player who types phrases without typing errors.

Then, in the typing game machine 1 of this embodiment, when it is determined that the replacement display by the group of selective character arrays 340 is to be made based on the replacement lottery table 345, the candidate number determination table 346 is used to determine the number of the candidate character arrays (refer to S44 in FIG. 31). To be more specific, as shown in FIG. 29, where the acquisition rate (correct answer rate) of points at the time concerned is equal or more than 0.5, the number of candidate character arrays is set to be 3. Further, where the acquisition rate (correct answer rate) of points is less than 0.5, the number of the candidate character arrays is set to be 2. Therefore, an increased number of candidate character arrays is given to the player having a higher point acquisition rate (correct answer rate) to raise the degree of difficulty in the game, and a decreased number of candidate character arrays is given to the player having a lower point acquisition rate (correct answer rate) to reduce the degree of difficulty in the game. It is, therefore, possible to conduct the game according to the level of the player, thereby enhancing the desire of the player to play the game. The candidate number determination table 346 is stored in a ROM 53 to be described later (refer to FIG. 13).

Then, an explanation will be made for the keyboard 6 provided in the typing game machine 1 by referring to FIGS. 10 and 11A. FIG. 10 is a plain view showing the keyboard provided in the typing game machine of the embodiment 1. FIG. 11A is a schematic cross sectional view showing the cross section of any one of a plurality of keys provided on the keyboard.

As shown in FIG. 10, the keyboard 6 is a Japanese language keyboard 108 in which a plurality of character enter keys 111 for entering “alphabetic letters (A to Z),” “Japanese syllabary (‘a’ to ‘n’),” “numerals (0 to 9)” and “symbols (period and comma)” as well as function keys 115 such as an enter key 112, a shift key 113 and cursor keys 114 are individually arranged. Then, while a game is in progress, a player types the character enter keys 111 corresponding to characters, symbols, numerals and others, thereby entering characters to advance the game. Further, prior to starting the game or after completion of the game, the player gives instructions to select and decide a musical composition for the game or the degree of difficulty or to start and execute the game by operating the function key 115. Light-emitting diodes are provided inside each of the keys on the keyboard 6, and the keys are constituted so as to emit light in various modes according to control signals provided from a CPU 51.

In this instance, an explanation will be made for the inner structure of the keyboard 6 by referring to FIG. 11A. The keys arranged on the keyboard 6 are all identical in inner structure. Hereinafter, an explanation will be made by referring to the inner structure of one character enter key 111 among a plurality of keys arranged on the keyboard 6, and an explanation will be omitted for the rest of the character enter keys 111 and the function keys 115.

As shown in FIG. 11A, the character enter key 111 is basically composed of a base plate 150, a switch circuit plate 151, a light-emitting circuit plate 152, a key top 153, an energizing mechanism 154, a full-color LED 155 and others.

In this respect, the switch circuit plate 151 arranged on the base plate 150 is provided with a pair of electrodes 156 disposed approximately below the center of the key top 153.

Further, the light-emitting circuit plate 152 attached on the switch circuit plate 151 is provided with an opening 157 for exposing a pair of electrodes 156, and the full-color LED 155 capable of lighting in a full color is provided around the opening 157.

The energizing mechanism 154 is provided between the light-emitting circuit plate 152 and the key top 153, and applies energy on key top 153 to the opposite side of the switch circuit plate 151 by the energizing mechanism 154. In addition, an electrode 158 is projected toward the switch circuit plate 151 approximately at the center of the key top 153. Since the electrode 158 projected on the key top 153 can be brought into contact with the a pair of electrodes 156 provided on the switch circuit plate 151 by depressing the key top 153, depression of the key top 153 can be transmitted as an electrical signal flowing through the switch circuit plate 151. That is, a key switch 159 is composed of these three electrodes 156 and 158.

The energizing mechanism 154 may be composed of an elastic body alone or with an elastic body and cross-linking mechanism. There is no particular restriction on the constitution.

Further, the key top 153 is formed with translucent materials (for example, transparent acryl and transparent plastic materials), and key information 160 such as characters, numerals and symbols are printed in black at the flat part on the surface. The surface of the light-emitting circuit plate 152 facing the key top 153 is also printed in black.

While the full color LED 155 is not lit, the translucent key top 153 is reflected in black which is a surface color of the light-emitting circuit plate 152. It is, therefore, difficult to recognize the key information 160 which is printed in black on the key top 153 reflected in black.

On the other hand while the full color LED 155 is lit, the translucent key top 153 is reflected in a lighting color derived from the full color LED 155. Therefore, the key information 160 which is printed in black on the key top 153 reflected in the lighting color can be easily recognized.

Then, in the keyboard 6a key switch 159 inside each key is connected to a signal sending circuit (not illustrated). The signal sending circuit is connected via an interface unit 52 to be described later (hereinafter, abbreviated as I/O) to the CPU 51 of the typing game machine 1. Therefore, when an electric signal from the key switch 159 depressed by the key is sent via the signal sending circuit to the CPU 51, it is possible to identify the type of depressed key. The signal sending circuit is loaded on the switch circuit plate 151.

Further, in the keyboard 6, the full color LED 155 inside the key is connected to an emission control circuit 62. The emission control circuit 62 is connected to the CPU 51 via the I/O 52 (refer to FIG. 13). It is, therefore, possible to light on the full color LED 155 inside the key in a color specified by the CPU 51 via the emission control circuit 62. To be more specific, where it is determined that key entry is made and determined that a correct typing is performed while a typing game is in progress in typing game machine 1 of this embodiment, the character enter key 111 is emitted in a blue color upon depression. Where it is determined that key entry is made and determined that an erroneous typing is performed, the character enter key 111 is emitted in a red color upon depression and a correct key to be entered is emitted in a green light. Further, where no key entry is made, only a correct key to be entered is emitted in a green color.

As shown in FIG. 12, the typing game machine 1 of the embodiment 1 is connected to a server 80 via a network N which can bi-directionally communicate such as the Internet. Then, the typing game machine 1 is able to update music data stored in the HDD 55 of the gaming machine 1 on the basis of the data sent from the data server 80 (refer to FIG. 13).

It is, therefore, possible to change types of musical composition which can be played in the typing game machine 1 by updating the music data. It is also possible to easily update the data by comprehensively controlling typing game machines installed at game shops.

Next, an explanation will be made for the constitution related to a control system of the typing game machine 1 by referring FIG. 13. FIG. 13 is a block diagram graphically showing the control system of the typing game machine of this embodiment.

As shown in FIG. 13, the control system of the typing game machine 1 is composed of a CPU 51 which controls game processing operations and others in the typing game machine 1, a ROM 53 and a RAM 54 connected to the CPU 51 and a peripheral unit (actuator) electrically connected to the CUP 51.

The CPU 51 is a central processing unit which conducts computing processes according to various commands. The I/O 52 is a part which electrically connects the CPU 51 with the liquid crystal display 3, the second liquid crystal display 4, the keyboard 6, the external illumination LEDs 7, the speakers 8 and others directly or indirectly. The ROM 53 is a non-volatile read-only memory which accommodates computing programs and others for actuating the replacement lottery table 345 (refer to FIG. 28), the candidate number determination table 346 (refer to FIG. 29) and a flow chart to be described later.

Further, the RAM 54 is a memory for temporarily storing various data computed at the CPU 51 and also storing the number of typing errors made by a player in the current typing game, acquired scores, acquired points, the number of total stages so far played by a player and others. In addition, among a plurality of music data stored in the HDD 55 to be described later, lyrics data of the music data used in the current typing game is divided into each phrase and temporarily stored in the RAM 54.

The HDD 55 is a storage unit which accommodates music data used when a typing game is conducted in the typing game machine 1. In this instance, the music data includes screen image data, performance data, audio data, lyrics data, determination criterion data, LED emission pattern data, keyboard emission pattern data and time-limit data, which is stored in individual storage areas of a music data storage area 56 formed inside the HDD 55 (refer to FIG. 14).

Further, the music data is stored in plurality (up to 8 in the embodiment 1) in the music data storage area 56. As described previously, individual music data stored on the basis of data sent from a data server 80 is updated, whenever necessary. Then, types of music titles displayed on the music selection screen 15 (refer to FIG. 2) are changed on the basis of types of music data stored in the data music data storage area 56, and a typing game is conducted according to the music data corresponding to musical compositions selected by the music selection screen 15 (refer to FIGS. 3A-3B and 4A-4C).

In this instance, a more detailed explanation will be made by referring to FIG. 14 for the music data storage area 56 provided in the HDD 55. FIG. 14 is a drawing for graphically explaining the music data storage area.

As shown in FIG. 14, the music data storage area 56 of the typing game machine 1 in this embodiment is composed of a plurality of storage areas (a first storage area to an eighth storage area in the embodiment 1) corresponding to the number of storable music data (8 musical compositions in the embodiment 1). Each storage area is provided with a screen image data storage area 56A, a performance data storage area 56B, an audio data storage area 56C, a lyrics data storage area 56D, a determination criterion data storage area 56E, an LED emitting pattern data storage area 56F, keyboard emitting pattern data storage area 56G and a time-limit data storage area 56H.

Hereinafter, an explanation will be made for each storage area. The screen image data storage area 56A is a storage area which stores screen image data on a PV screen image 20 of an artist displayed on the second liquid crystal display 4, among the music data (refer to FIGS. 3A and 4A).

The performance data storage area 56B is a storage area which stores performance data on instrumental accompaniment output from the speakers 8 among the music data.

Further, the audio data storage area 56C is a storage area which stores audio data on a singing voice sung by an artist output from the speakers 8 among the music data.

In addition, the lyrics data storage area 56D is a storage area which stores lyrics data on document data of musical composition lyrics among the music data. The lyrics data may include the following information. A range of character arrays corresponding to each phrase of the lyrics may be replaced by the group of selective character arrays 340 including the correct character array (for example, “HA BA TA KE RU” in FIG. 26B) and incorrect character arrays (for example, “HA BA YO SE RU” and “HA DA KE RU” in FIG. 26B), which are also recorded. Then, as described previously, when the typing game is conducted, each phrase of the lyrics is displayed on the first liquid crystal display 3 (refer to FIGS. 3B and 4B).

Then, the determination criterion data storage area 56E is a storage area which stores determination criterion data on criteria for whether or not a player types characters correctly and at a correct timing while a typing game is in progress, among the music data. The CPU 51 adds the number of typing errors, scores, points and others on the basis of the stored determination criterion data and operation signals from the keyboard 6.

The LED emitting pattern data storage area 56F and the keyboard emitting pattern data storage area 56G are storage areas which store LED emitting pattern data for emitting the external illumination LEDs 7 and keyboard emitting pattern data for emitting a full color LED 155 installed inside the key, among the music data. In the typing game machine 1 of the embodiment 1, these eight external illumination LEDs 7 are controlled so as to provide individual light-emitting modes (for example, emission color, lighting on and lighting off) by an emission control circuit 62 to be described later while a typing game is in progress on the basis of the stored LED emitting pattern data. Further, the full color LED 155 provided inside the key is controlled so as to provide individual light-emitting modes (for example, emission color, lighting on and lighting off) by the emission control circuit 62 to be described later while a typing game is in progress on the basis of the stored keyboard emitting pattern data. Light-emitting patterns of the full color LED 155 include a light-emitting pattern for a beginner of a typing game in which key entry is assisted by lighting on the key to be entered in sequence in an illumination color different from that of a whole of the keyboard 6 and a pattern in which all the keys arranged on the keyboard 6 are changed in illumination color in accordance with an image of the musical composition concerned.

The time-limit data storage area 56H is a storage area which stores time-limit data on the expiration date of music data among the music data, and the time-limit data includes data of two dates, namely, the date when the music data is usable (use commencement date) and the date when the music data becomes unusable (use completion date). The time-limit data becomes used in controlling the expiration date of individual music data, together with a timer 58 (refer to FIG. 13), and the CPU 51 controls so that no typing game can be played by using the music data, the date of which is expired.

In this instance, an explanation will be made for the control system of the typing game machine 1 by referring to FIG. 13 again.

The game communications means 57 is a unit in which signals sent from the typing game machine 1 are converted to transmittable signals according to communications forms such as telephone lines and LAN cables, and sent to a server 80, signals sent from the server 80 are received and converted again to signals that can be read by the typing game machine 1. This unit is connected via the network N which can bi-directionally communicate such as a server communications means 81 of the server 80 and the Internet (refer to FIG. 12).

Further, a timer 58 is connected to the CPU 51. Information on the timer 58 is sent to the CPU 51, and the CPU 51 controls the expiration date of stored music data by referring to the information on the timer 58 and the time-limit data stored in the time-limit data storage area 56H of the HDD 55.

The CPU 51 is connected to a clock pulse generating circuit 70 which generates a reference clock pulse and to a frequency divider 71. It is also connected to a random number generator 72 which generates random numbers and to a random number sampling circuit 73. Random numbers sampled via the random number sampling circuit 73 are used in various lotteries such as replacement determination by the blank character region 40 (refer to S42 in FIG. 18).

Further, a display control circuit 60 is connected to the CPU 51 via the I/O 52 and controls the contents displayed by the first liquid crystal display 3 and the second liquid crystal display 4, according to computing processing results of the CPU 51. In this instance, the display control circuit 60 is composed of a program ROM, an image ROM, an image control CPU, a work RAM, a VDP (video display processor), a video ROM and others. Then, the program ROM accommodates image control programs on display by the first liquid crystal display 3 and the second liquid crystal display 4 as well as various selection tables. Further, the image ROM accommodates dot data for forming various images, for example, a music selection screen 15 (refer to FIG. 2), a main game screen 21 (refer to FIG. 3 and FIG. 4) and a game result screen 30 displayed on the first liquid crystal display 3.

Then, the image control CPU decides an image displayed on the first liquid crystal display 3 and the second liquid crystal display 4 from the dot data stored in advance in the image ROM according to the image control program in advance stored in the program ROM on the basis of parameters set by the CPU 51. Additionally, the VDP forms an image according to display contents determined by the image control CPU, outputting the image on the first liquid crystal display 3 or the second liquid crystal display 4.

Therefore, for example, in a standby state, demonstration screens including PV of any given musical composition, advertisement and a ranking list are displayed. After coins are inserted into the coin insertion slot 9, the music selection screen 15 is displayed on the first liquid crystal display 3 (refer to FIG. 2). Then, when a typing game is started and conducted in the typing game machine 1, control is given, for example, lyrics data which constitute music data are displayed for each phase on the first liquid crystal display 3, and the character array 23A already typed by a player on the basis of the entered result of the keyboard 6 is displayed at the Roman character display part 23. Further, where it is determined that the group of selective character arrays 340 partially replaces the character array 22A for display on the basis of lottery results, the group of selective character arrays 340 constituting the first and the second candidate display parts 340A and 340B, or the first to the third candidate display parts 340A to 340C is displayed in the lyrics displaying part 22 (refer to FIGS. 26A-26C). On the other hand the PV which is screen image data constituting the music data is displayed on the second liquid crystal display 4.

A sound control circuit 61 is connected to the CPU 51 via the I/O 52, and also to the speakers 8. Then, when a typing game is conducted and music data stored in a music data storage area 56 of the HDD 55 is read out, performance data and audio data constituting the music data are converted to sound signals by the sound control circuit 61 and output from the speakers 8.

Then, an emission control circuit 62 is connected to the CPU 51 via the I/O 52 and also connected to the external illumination LEDs 7 and the full color LED 155 disposed inside the key (refer to FIG. 11). When music data stored in the music data storage area 56 of the HDD 55 are read out by the CPU 51, the emission control circuit 62 controls light emitting modes of the external illumination LEDs 7 and the full color LED 155 on the basis of LED emitting pattern data and keyboard emitting pattern data constituting the music data.

Further, the CPU 51 is connected to the keyboard 6. A key switch 159 provided inside each key of the keyboard 6 sends the fact that the key top 153 is depressed as an electrical signal flowing through the switch circuit plate 151. The CPU 51 controls to execute various operations corresponding to each key on the basis of a switch signal output from each of the key switch 159 upon depression of the keys.

The coin sensor 63 is a sensor for detecting coins (for example, 100 yen coins) used as a value in conducting a typing game in the typing game machine 1. The coin sensor 63 is disposed inside a coin insertion slot 9 and connected to the CPU 51 via the I/C 52. Therefore, the coin sensor 63 sends a coin insertion signal to the CPU 51 on the basis of coins inserted into the coin insertion slot 9. Then, the CPU 51 detects the coin insertion signal corresponding to a predetermined amount (for example, 200 yen), thereby allowing to play the typing game.

Further, the card sensor 64 is also a sensor for detecting whether an IC card is inserted into the card insertion slot 10 or not, and the card reader/writer 65 is a unit for reading and writing an IC tag disposed on the IC card. The card sensor 64 and the card reader/writer 65 are disposed inside the card insertion slot 10 and connected to the CPU 51 via the I/O 52. Then, when the IC card is detected by the card sensor 64 and a predetermined operation is conducted, the card reader/writer 65 reads the result of a typing game from the IC tag (S3 in FIG. 15). When the typing game is completed, new game results (acquired scores and points) are written into the IC tag (S9 in FIG. 15).

As explained before with respect to FIG. 15, the main processing program is conducted in the typing game machine 1 having the above-described configuration.

Then, in S6, a typing game conduction process is carried out according to a musical composition set in the S5, as shown in FIG. 30. As is explained later, in the typing game conduction process, the musical composition is performed and scores, points and others are added on the basis of typing results of the keyboard 6 to continue a typing game until predetermined completion requirements are met.

Thereafter, when the typing game conduction process is completed, a game result display process is carried out as shown in FIG. 15.

The following processes are carried out in a similar manner as shown in FIGS. 15 and 16.

Then, an explanation will be made by referring to FIG. 30 for a typing game conduction process program carried out by the typing game machine 1 in the S6 (FIG. 15). FIG. 30 is a flow chart showing the typing game conduction process program for the embodiment 1.

In the typing game conduction process, first, the CPU 51 reads out music data corresponding to the musical composition selected by the musical composition selection process in the S5, among music data stored at each storage area (refer to FIG. 14) of the music data storage area 56 of the HDD 55 in S21. Then, in particular, lyrics data accommodated in the lyrics data storage area 56D are divided into each phrase and temporarily stored in the RAM 54.

Next, the main game screen (refer to FIGS. 3B and 4B) is displayed on the first liquid crystal display 3 in S22. At this moment, a character array is not displayed at the lyrics displaying part 22 or at the Roman character display part 23, and the points and score of the score displaying part 27 is displayed as “zero.”

In S23, the PV screen image 20 of the musical composition selected on the second liquid crystal display 4 is started to be displayed on the basis of the screen image data stored in the screen image data storage area 56A (refer to FIGS. 3A and 4A). Further, music for accompaniment is output on the basis of performance data stored in the performance data storage area 56B and voice is output on the basis of audio data stored in the audio data storage area 56C individually via the speakers 8, by which the musical composition is performed and the PV screen image 20 is reproduced accordingly.

Next, in S24, lyrics equivalent to one phase of the lyrics data accommodated in the MRA 54 is obtained. The character array 22A corresponding to the thus obtained lyrics data is subjected to a character array display process displayed at the lyrics displaying part 22 of the main game screen 21 as shown in FIG. 30 (S325). In the character array display process, as described later, a lottery process is carried out in which it is determined by the lottery whether the character array 22A is partially replaced by the group of selective character arrays 340 for display or not (whether the character array is partially non-displayed or not). The character array 22A and the group of selective character arrays 340 are displayed according to the lottery result.

Thereafter, in S26, the number of characters for one phrase, n, is calculated on the basis of the one-phrase lyrics data obtained in the S24 and zero is assigned to any given variable m accommodated in the RAM 54 (S27). In this instance, any given variable m is a variable used in entry determination for a character corresponding to each character constituting one phrase and a variable is added by one each time when an entry determination of one character is completed (S34). Therefore, in each entry determination process repeated in the following S28 to S35, when m=t (0≦t≦n−1), an entry determination is to be made for a character which is located at (t+1)^{th} on calculation from the first character of one phrase.

Further, in S28, a determination is made for whether key entry is made by the character enter key 111 or not, on the basis of an operation signal sent from the keyboard 6. Where it is determined that key entry has been made (S28; Yes), a determination is made for whether keys are correctly entered or not on the basis of types of keys depressed and the determination criterion data stored in the determination criterion data storage area 56E (S29). To be more specific, it is recognized as correct typing when a key corresponding to the character array 22A displayed at the lyrics displaying part 22 of the main game screen 21 (refer to FIGS. 3B and 4B) is depressed. Then, where it is determined that a key other than the corresponding key has been depressed, the number of typing errors is added by one. Thereafter, the typing game machine proceeds to S32.

On the other hand, where it is found that no key entry has been made (S28: No), a determination is made for whether a predetermined time on the basis of the information on a timer 58 (calculation is made after a character array corresponding to one phrase is displayed in relation to the main game screen 21 when the first character of one phrase is entered (S25), whereas calculation is made after a score calculation process when other characters are entered (S33)) has passed or not (S30). Then, where it is determined that a predetermined time has not passed (S30: No), the typing game machine returns to the process in S28.

In contrast, where the CPU 51 determines that a predetermined time has passed (S30: Yes), the number of typing errors in the current game accommodated in the RAM 54 is added by one, on the assumption that no key entry has been made by a player (S31).

Then, in S32, the light emitting process for a key is carried out on the basis of the full color LED 155 provided inside the keyboard 6. To be more specific, in the typing game machine 1 of the embodiment 1, where it is determined that key entry is made (S28: Yes) and a correct typing is also made, the depressed character enter key 111 is emitted in a blue color. Further, where it is determined that key entry is made (S28: Yes) and an erroneous typing is made at the same time, the depressed character enter key 111 is emitted in a red color and a correct key to be entered is emitted in a green color. Further, where no key entry is made (S28: No), a correct key to be entered is emitted in a green color.

Further, in S33, a score calculation process is carried out on the basis of the determination process in the S29 on whether keys are correctly entered or not. In the score calculation process, a score is added where it is determined that the score obtained by a player in the current game and accommodated in the RAM 54 is correctly typed by referring to the above determination process. Also, an additional score is added where it is determined that characters are typed at the same timing with the voice of the musical composition to be performed.

Thereafter, in S34, a variable m accommodated in the RAM 54 is read out to add “+1” and the variable is again accommodated. Then, in S35, a determination is made for whether a value of the variable m has reached n−1 or not, namely, whether all entry determinations for each character that forms one phrase have been completed.

Then, where it is determined that the value of the variable m does not reach n−1 (S35: No), the typing game machine again returns to S28, and an entry determination is made for a character located following position among the characters which form one phrase.

On the other hand where it is determined that the value of the variable m has reached n−1 (S35: Yes), it is deemed that all characters of one phrase have been completely entered. Therefore, in S36, a point adding process is carried out. In the point adding process, where it is determined that n characters constituting one phrase have been completely entered without any typing errors (including determination of typing errors due to passage of a predetermined time (S31)), one point is added.

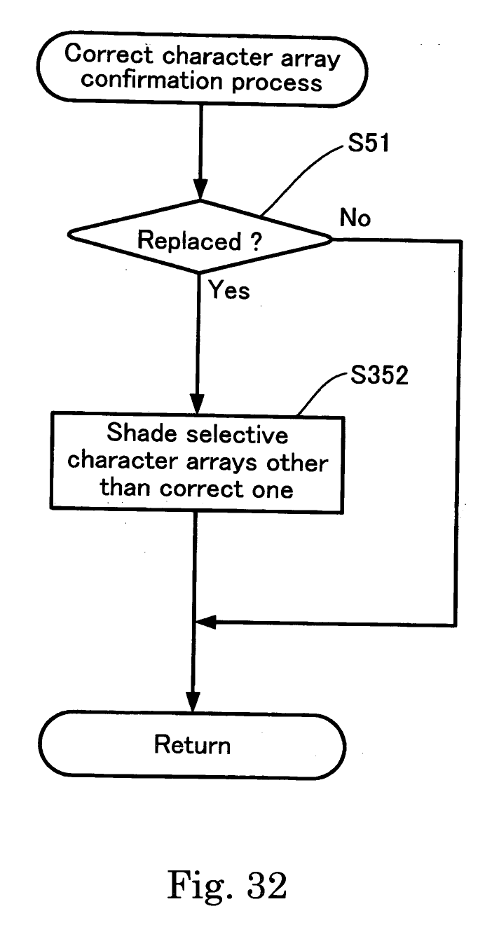

Thereafter, a correct character array confirmation process in FIG. 32 is conducted in S337. In the correct character array confirmation process, where the group of selective character arrays 340 is displayed by replacing part of the character array 22A, the other parts of the first to the third candidate display parts 340A to 340C than the one showing the correct character array are non-displayed or hidden (for example, the first candidate display part 340A in FIGS. 27A and 27B).

Further, in S38, a determination is made for whether or not an entry determination has been completed for a phrase of a stage corresponding to any tune number among a plurality of tune numbers constituting a musical composition (usually one musical composition is composed of one to three tune numbers). Then, where it is determined that an entry determination has not been completed for a whole phrase covering one stage (S38: No), the typing game machine returns to S24. Lyrics of a next phrase are obtained from the RAM 54 and the corresponding character array is displayed at the lyrics displaying part 22 on the main game screen 21.

In contrast, where it is determined that an entry determination has been completed for a whole phrase covering one stage (S38: Yes), a determination is continuously made for whether an entry determination has been completed for phrases covering a whole stage or not (all the tunes in a musical composition) (S39).

Then, where it is determined that a whole stage has been completed (S39: Yes), irrespective of any points owned by a player, the current typing game conduction process is completed, and the typing game machine proceeds to a game result displaying process in S7. On the other hand where it is determined that a whole stage has not been completed (S39: No), a determination is then made for whether the number of typing errors made so far by a player added in the S29 and S31 is less than a predetermined number of typing errors or not (S40). The typing game machine 1 of this embodiment is composed of a plurality of stages according to the number of tune numbers of reproduced musical compositions. In order to play a stage related to a next tune number at a time when one stage has been completed, the number of typing errors made so far from the start of a game must be less than a predetermined number of typing errors. (For example, the number of typing errors must be less than 20 times in order to continue to play a part of number 2 after a part of number 1, and the number must be less than 35 times in order to continue to play a part of number 3 after a part of number 2.)

Then, where it is determined that the number of typing errors made so far by a player added in the S29 and S31 is less than a predetermined number of typing errors (S40: Yes), the typing game machine returns to S24. Lyrics corresponding to the first phrase of the next tune number are obtained from the RAM 54, and the corresponding character array is displayed at the lyrics displaying part 22 on the main game screen 21. Then, an entry determination process is carried out similarly. On the other hand, where it is determined that the number of typing errors made by a player is more than a predetermined number of typing errors (S40: No), the typing game conduction process is completed, and the typing game machine proceeds to the game result displaying process in S7.

Next, an explanation will be made by referring to FIG. 31 for a character array displaying process program of the S25 conducted in the typing game machine 1. FIG. 31 is a flow chart of the character array displaying process program for the embodiment 1.

In the character array displaying process, first, when a phrase corresponding to the lyrics data obtained in the S24 is displayed in S41, a replacement display lottery process is carried out for determining by lottery whether the displayed character array 22A is partially replaced by the group of selective character arrays 340 or not. To be more specific, the replacement lottery table 345 (FIG. 28) is used to conduct the lottery according to a random number value sampled with the random number sampling circuit 73.

Then, in the subsequent determination process in S42, a determination is made for whether the character array 22A is partially replaced by the group of selective character arrays 340 for display or not, on the basis of the lottery result of the replacement display lottery process in the S41. To be more specific, where the sampled random number value is in the range from “0” to “3,” it is determined that the character array is replaced by the group of selective character arrays 340 for display (S42: Yes), and the typing game machine proceeds to S43. On the other hand where the sampled random number value is in the range from “4” to “19,” it is determined that the whole phrase of the character array 22A is displayed without replacement by the group of selective character arrays 340 (S42: No), and the typing game machine proceeds to S47.

Further, a point acquisition rate (correct answer rate) is calculated in S43. “Points acquired so far by a player” stored in the RAM 54 are divided by “total number of stages played up to the current game” stored in also the RAM 54 to calculate the point acquisition rate.

Then, in S44, the point acquisition rate calculated in the S43 and a candidate number determination table 346 (refer to FIG. 29) are used to determine the number of candidate character arrays. To be more specific, where the acquisition rate of points (correct answer rate) is equal to or more than 0.5 (S44: Yes), the number of candidate character arrays is set to be 3. The character array 22A corresponding to the lyrics data obtained in the S24 and the group of selective character arrays 340 composed of the first to the third candidate display parts 340A to 340C are displayed respectively in the lyrics displaying part 22 of the main game screen 21 (refer to S345, FIG. 26B). In this instance, the character array 22A is displayed with a part of the character array (for example, “HA BA TA KE RU” in FIG. 6B) defined in advance by the lyrics data being replaced by the group of selective character arrays 340.

On the other hand where the point acquisition rate (correct answer rate) is less than 0.5 (S44: No), the number of candidate character arrays is set to be 2. The character array 22A corresponding to the lyrics data obtained in the S24 and the group of selective character arrays 340 being composed of the first candidate display part 340A and the second candidate display part 340B are individually displayed in the lyrics displaying part 22 of the main game screen 21 (refer to S346, in FIG. 26A). In this instance, the character array 22A is a part of the character array having been defined in advance by the lyrics data (for example, “HA BA TA KE RU” in FIG. 26A) and being replaced by the group of selective character arrays 340.

Further, where it is determined by the determination process in the S42 that the entire phrase of the character array 22A is displayed without replacement by the group of selective character arrays 340, the entire character array 22A corresponding to the lyrics data obtained in the S24 is displayed in the lyrics displaying part 22 on the main game screen 21 (refer to S347, FIG. 4B). Thereafter, the character array displaying process is completed, and the typing game machine proceeds to the process in S26.

Then, an explanation will be made by referring to FIG. 32 for a correct character array confirmation process program of the S337 which is carried out in the typing game machine 1. FIG. 32 is a flow chart of the correct character array confirmation process program for this embodiment.

In the correct character array confirmation process, first, in S51, a determination is made on the basis of the lottery result of the replacement display lottery process in the S41 for whether the character array 22A of the phrase now being displayed is partially replaced by the group of selective character arrays 340 or not. Then, where it is determined that the entire character array 22A is displayed without replacement by the group of selective character arrays 340 (S51: No), the correct character array confirmation process is completed, and the typing game machine proceeds to the determination process in S38.

On the other hand where it is determined that the character array is replaced by the group of selective character arrays 340 for display (S51: Yes), the display mode is controlled such that any of the first to third candidate display parts having wrong character arrays other than the correct array corresponding to the phrase of the lyrics (for example, “HA BA YO SE RU” and “HA DA KE RU” in FIG. 26B) are non-displayed (or hidden) from the main game screen 21 (Refer to FIG. 27). In this way, the player may be able to recognize the correct character array selected from a plurality of candidates.

Thereafter, the correct character array confirmation process is completed, and the typing game machine proceeds to the determination process in S38.

As explained so far, in the typing game machine 1 of this embodiment, after coins are inserted into the coin insertion slot 9 to start the typing game conduction process (S6), as the character array 22A of one phrase corresponding to the lyrics of the musical composition is to be displayed on the main game screen 21 of the first liquid crystal display 3, a lottery process is carried out for determining whether the phrase is partially replaced by the group of selective character arrays 340 (S41). Where it is determined on the basis of the lottery result that the phrase is partially displaced and displayed (S42: Yes), the character array is partially replaced by the group of selective character arrays 340 composed of two or three candidate display parts for display. Therefore, in addition to typing, a new gaming mode, namely selecting one of the selective character arrays, can be provided to improve the game amusement. Thus, the game would not become monotonous even when the game is played repeatedly and it may be prevented the player from getting bored with the game. Further, since the player is not able to obtain a high score unless he or she memorizes the lyrics of the musical composition, even an experienced player is also able to enjoy the game.

Further, since it is randomly determined whether replacement by the group of selective character arrays 340 would be made on the basis of the lottery result, it is possible to display the group of selective character arrays 340 at an unpredictable timing for the player, thereby improving the game amusement. In addition, since the group of selective character arrays is displayed at a different timing for each game even when the game is played repeatedly, it may be prevented that the player gets bored with the game.

Since the number of the candidate character arrays of the group of selective character arrays may vary depending on the point acquisition rate (correct answer rate) (S44 to S46), an increased number of the candidate character arrays is given to the player having a higher point acquisition rate (correct answer rate) to raise the degree of difficulty in the game and a decreased number of the candidate character arrays is given to the player having a lower point acquisition rate (correct answer rate) to reduce the degree of difficulty in the game. It is, therefore, possible to conduct the game according to the level of the player, thereby enhancing his or her desire to play the game.

The typing game machine 1 of the embodiment 1 is provided with two liquid crystal displays, namely, the first liquid crystal display 3 and the second liquid crystal display 4. More particularly, a PV screen image 20 of the musical composition to be performed is displayed on the second liquid crystal display 4 disposed above the cabinet (S23) and a main game screen 21 displaying a character array corresponding to lyrics of the musical composition is displayed on the first liquid crystal display 3 disposed below the cabinet 2 in parallel therewith (S22, S24), thus making it possible to provide various typing games using contents displayed on two screens, in comparison with the use of a single liquid crystal display. Therefore, a player does not get bored with a typing game and given an increased willingness to play the game.

Since the PV screen image 20 which is not directly needed in advancing a typing game is not displayed on the main game screen 21, a player can obtain necessary information more easily and play the game in a more concentrated manner.

Further, the PV screen image 20 is displayed on an independent liquid crystal display, thereby making it possible to display an artist singing a song in tune with a musical composition and conduct a typing game in a warmed up ambience than would otherwise be realized conventionally. Therefore, a player does not get bored with the game.

The present invention is not restricted to the above embodiments but a variety of modifications may be made without departing from the spirit and scope of the invention.

For example, in the typing game machine of the embodiment 1, a determination is made for whether a player is familiar with a game or not by referring to the level of point acquisition rate (correct answer rate) (S44), thereby changing the number of candidate character arrays of the group of selective character arrays. The number of the candidate character arrays may be determined by referring to a percentage of typing errors in relation to the total number of stages played by the player.

Further, in this embodiment, the number of the candidate character arrays is set to be either two or three and the group of selective character arrays 340 is to be displayed. However, the number of the candidate character arrays is not limited to this, but it may be four or five. Further, the character array 22A may be displayed with partially broken characters instead of appearing with the candidate character arrays.

By way of example, there is also provided such a typing machine comprising: image display means (e.g., 1st liquid crystal display 3, 2nd liquid crystal display 4) for displaying a predetermined character array (e.g., character array 22A) relating to a game; input means (e.g., keyboard 6) including a plurality of arranged keys corresponding to a plurality of characters; true/false determination means (e.g., CPU 51, S29) for determining whether a character array inputted from the input means matches the predetermined character array; game control means (e.g., CPU 51) for controlling the game based on a determination result by the true/false determination means; and display control means (e.g., CPU 51, display control circuit 60) for hiding part or all of the predetermined character array to be displayed upon satisfaction of a predetermined condition.

Further, the above-described typing game machine (e.g., typing game machine 1) may comprise: timing determination means (e.g., CPU 51, S41) for determining a timing to hide the part or all of the predetermined character array (e.g., character array 22A), wherein it is determined whether the predetermined condition is satisfied or not at the timing determined by the timing determination means.

Also, the above-described typing game machine (e.g., typing game machine 1) may be characterized in that the display control means (e.g., CPU 51, display control circuit 60) changes length of the character array to be hidden based on the determination result by the true/false determination means (e.g., CPU 51, S29).

Also, the above-described typing game machine (e.g., typing game machine 1) may further comprise: music data storage means (e.g., HDD 55) for storing music data; and musical composition play processing means (e.g., CPU 51, music control circuit 61) for outputting a voice as well as playing music at a predetermined tempo based on the music data stored by the music data storage means, wherein the predetermine character array (e.g., character array 22A) relates to the voice outputted by the musical composition play processing means.

There may also be provided a typing game machine comprising: music data storage means (e.g., HDD 55) for storing music data; musical composition play processing means (e.g., CPU 51, music control circuit 61) for playing music based on the music data stored by the music data storage means; image display means (e.g., 1st liquid crystal display 3 and 2nd liquid crystal display 4) for displaying a predetermined character array (e.g., lyrics of the music) relating to the music played by the musical composition play processing means; input means (e.g., keyboard 6) including a plurality of arranged keys corresponding to a plurality of characters; true/false determination means (e.g., CPU 51, S128) for determining whether a character array inputted from the input means matches the predetermined character array; game control means (e.g., CPU 51) for controlling a game based on a determination result by the true/false determination means; and display control means (e.g., CPU 51, S116) for hiding all of the predetermined character array to be displayed on the image display means.

Further, the above-described typing game machine may comprise: game mode selection means (e.g., CPU 51, S105) for selecting one from a plurality of kinds of game modes, wherein the display control means hides all of the predetermined character array upon selection of a predetermined game mode (e.g., ULTRA HARD mode) by the game mode selection means.

As a further example, there is also provided a typing game machine (e.g., typing game machine) comprising: image display means (e.g., 1st liquid crystal display 3 and 2nd liquid crystal display 4) for displaying a predetermined character array relating to a game; input means (e.g., keyboard 6) including a plurality of arranged keys corresponding to a plurality of characters; true/false determination means (e.g., CPU 51, S29) for determining whether a character array inputted from the input means matches the predetermined character array (e.g., character array 22A); game control means (e.g., CPU 51) for controlling the game based on a determination result by the true/false determination means; and display control means (e.g., CPU 51 and display control circuit 60) for displaying a group of selective character arrays in replacement of part or all of the predetermined character array to be displayed.

The above-described typing game machine (e.g., typing game machine 1) further may comprise timing determination means (e.g., CPU 51, S41) for determining a timing to display the group of selective character arrays (e.g., a group of selective character arrays 340), wherein the display control means (e.g., CPU 51 and display control circuit 60) displays the group of selective character arrays in replacement of the part or all of the predetermined character array at the timing determined by the timing determination means.

The above-described typing game machine (e.g., typing game machine 1) may be characterized in that the display control means (e.g., CPU 51 and display control circuit 60) changes the number of the selective character arrays constituting the group based on the determination result by the true/false determination means (e.g., CPU 51, S29).

In the above-described typing game machine, the predetermined character array may be partially or totally displayed or non-displayed upon satisfaction of the predetermined condition so that a new game mode that the character array to be typed has to be guessed is added to just typing, thereby enabling improvement of amusement of the game. Therefore, the game may not become monotonous even though the game is played repeatedly, thereby preventing the player from being bored.

And in the above-described typing game machine, the predetermined character array may be hidden (or non-displayed) at the timing as the timing determination means determines such that it is possible to hide the predetermined character array at the timing when the player cannot predict, thereby the amusement of the game is enhanced. Further, even though the game is repeated, the timing when the character array is hidden may vary in each repeated game, thereby preventing the player from being bored.

Also, in the above-described typing game machine, the length of the character array to be hidden is changed based on the determination results by the true/false determination means such that it is possible to vary the level (easiness) of the game in the basis of the correct typing rate. Therefore, it is possible to provide the game with an adjusted level to the player, who may have more desire to play the game.

Also, in the above-described typing game machine, music and voice are outputted at a specified tempo in the basis of the stored music data and the true/false determination whether or not it matches with the character array of the outputted voice is conducted such that it is possible to perform the typing game in a lively environment as the player types in tune with the played music, thereby preventing the player from being bored.

Also, in the above-described typing game machine, it is possible to provide a new type of game in which the player types the characters to be inputted by hearing the performed music, but not by recognizing the displayed characters to be typed with the eyesight. Since the player may not be able to get high scores unless the lyrics of the music are memorized such that his or her desire to play the game repeatedly is enhanced and even a highly-skilled player can enjoy the game.

Also, in the above-described typing game machine, since the image display means displays no characters to be typed in the game when a predetermined mode is selected, it is possible to provide a new type of game at the player's choice that he or she is supposed to type characters by recognizing the characters to be inputted and the input timing as he or she listens to the performed music, but not by recognizing the displayed characters to be inputted with the eyesight. And since the player cannot get high scores unless he or she memorizes the lyrics of the music, his or her desire to play the game repeatedly is enhanced and even a highly-skilled player can enjoy the game.

In the above-described typing game machine, since part or all of the predetermined character array to be displayed is replaced by the group of different selective character arrays such that there is configured a new game mode that the character array to be typed is selected based on the group in addition to just typing the characters and it is possible to enhance the amusement of the game. Therefore, the game would not become monotonous even if it is repeated so as to prevent the player from being bored.

Also, in the above-described typing game, since the group of selective character arrays is displayed by replacing the character array to be typed at the timing when the timing determination means determines, it is possible to display the group at the timing when the player cannot predict, thereby enabling higher amusement. Further, since the timing when the group is displayed varies for each game even though the game is repeated over and over again, it is prevented the player from being bored.

Also, in the above-described typing game machine, the number of the selective character arrays is changed based on the determination results by the true/false determination means such that it is possible to vary the level (easiness) of the game in the basis of the correct typing rate. Therefore, it is possible to provide the game with an adjusted level to the player, who may have more desire to play the game.

Also, in the above-described typing game machine, music and voice are outputted at a specified tempo in the basis of the stored music data and the true/false determination whether or not it matches with the character array of the outputted voice is conducted such that it is possible to perform the typing game in a lively environment as the player types in tune with the played music, thereby preventing the player from being bored.

What is claimed is:

1. A typing game machine comprising:
a display device; and
a keyboard,
wherein the typing game machine performs a game that provides higher evaluation for higher matching rate between a predetermined character array to be inputted and a character array actually inputted from the keyboard in accordance with a game image displayed on the display device by comparing respective characters constituting the character arrays,
wherein the predetermined character array to be inputted is displayed on the display device in a base mode, and
wherein at least part of the predetermined character array to be inputted is hidden or replaced by a selective display image upon satisfaction of a predetermined condition.

2. The typing game machine according to claim 1, comprising:
a sound generation device,
wherein the sound generation device generates a sound relating to the game image such that a player is urged to input characters constituting the predetermined character array.

3. The typing game machine according to claim 2,
wherein the sound relating to the game image comprises music,
wherein the predetermined character array is at least part of lyrics of the music, and
wherein the at least part of the predetermined character array that is hidden or replaced by the selective display image is not generated in a voice by the sound generation device.

4. The typing game machine according to claim 1,
wherein the predetermined condition is a predetermined timing, and
wherein the hidden part of the predetermined character array is replaced by blank space on the display device.

5. The typing game machine according to claim 2,
wherein the predetermined condition is a predetermined timing, and
wherein the hidden part of the predetermined character array is replaced by blank space on the display device.

6. The typing game machine according to claim 3,
wherein the predetermined condition is a predetermined timing, and
wherein the hidden part of the predetermined character array is replaced by blank space on the display device.

7. The typing game machine according to claim 4,
wherein a number of characters constituting the hidden part is determined to be increased if latest evaluation results show an increasing tendency, and
wherein the number of characters constituting the hidden part is determined to be decreased if the latest evaluation results show a decreasing tendency.

8. The typing game machine according to claim 5,
wherein a number of characters constituting the hidden part is determined to be increased if latest evaluation results show an increasing tendency, and
wherein the number of characters constituting the hidden part is determined to be decreased if the latest evaluation results show a decreasing tendency.

9. The typing game machine according to claim 6,
wherein a number of characters constituting the hidden part is determined to be increased if latest evaluation results show an increasing tendency, and
wherein the number of characters constituting the hidden part is determined to be decreased if the latest evaluation results show a decreasing tendency.

10. The typing game machine according to claim 1,
wherein the predetermined condition is a predetermined timing, and
wherein the selective display image includes the predetermined character array being composed of characters to be inputted and a comparative character array having a similar number of characters constituting the comparative character array to a number of the characters to be inputted, the characters constituting the comparative character array being at least partially different from the characters to be inputted.

11. The typing game machine according to claim 2,
wherein the predetermined condition is a predetermined timing, and
wherein the selective display image includes the predetermined character array being composed of characters to be inputted and a comparative character array having a similar number of characters constituting the comparative character array to a number of the characters to be inputted, the characters constituting the comparative character array being at least partially different from the characters to be inputted.

12. The typing game machine according to claim 3,
wherein the predetermined condition is a predetermined timing, and
wherein the selective display image includes the predetermined character array being composed of characters to be inputted and a comparative character array having a similar number of characters constituting the comparative character array to a number of the characters to be inputted, the characters constituting the comparative character array being at least partially different from the characters to be inputted.

13. The typing game machine according to claim 10,
wherein another comparative character array is determined to be added to the selective display image if latest evaluation results show an increasing tendency, and
wherein the comparative character array is determined to be removed from the selective display image if the latest evaluation results show a decreasing tendency.

14. The typing game machine according to claim 11,
wherein another comparative character array is determined to be added to the selective display image if latest evaluation results show an increasing tendency, and
wherein the comparative character array is determined to be removed from the selective display image if the latest evaluation results show a decreasing tendency.

15. The typing game machine according to claim 12,
wherein another comparative character array is determined to be added to the selective display image if latest evaluation results show an increasing tendency, and
wherein the comparative character array is determined to be removed from the selective display image if the latest evaluation results show a decreasing tendency.
